(19) United States
(12) Patent Application Publication
(10) Pub. No.: US 2026/0177516 A1
(43) Pub. Date: Jun. 25, 2026

(54) STRUCTURALLY COLORED MXENE LAYER-BY-LAYER HETEROSTRUCTURES

(71) Applicant: The Texas A&M University System, College Station, TX (US)

(72) Inventors: Natalie Neal, Pittsburgh, PA (US); Miladian Radovic, College Station, TX (US); Micah Green, College Station, TX (US); Jodie Lutkenhaus, College Station, TX (US)

(21) Appl. No.: 19/428,866

(22) Filed: Dec. 22, 2025

Related U.S. Application Data
(60) Provisional application No. 63/737,824, filed on Dec. 23, 2024.

(51) Int. Cl. G01N 27/04; C09D 7/61; C09D 125/18; C09D 139/00; G01N 21/81

(52) U.S. Cl. CPC G01N 27/048; C09D 7/61; C09D 125/18; C09D 139/00; G01N 21/81

(57) ABSTRACT

Disclosed herein are systems and methods for producing structural color in layer-by-layer assemblies of Ti₃C₂T_{z} MXene nanosheets and polyelectrolyte heterostructures with controlled block thicknesses. In an aspect, the block thickness and spatial placement of MXene is controlled by the assembly's salt concentration and number of layer pairs. In a further aspect, to achieve controllable thicknesses in MXene blocks a processing method called layer-by-layer (LbL) assembly is employed. LbL assembly uses electrostatic interactions to alternately deposited layers of desired materials. In a still further aspect, layers of desired thicknesses can be built up by sequential deposition, allowing the creation of MXene blocks of specific thicknesses in order to attain structural color.

### CROSS-REFERENCE TO RELATED APPLICATIONS

This application claims the benefit of U.S. Provisional Application No. 63/737,824 filed on Dec. 23, 2024, which is incorporated herein by reference in its entirety.

### STATEMENT REGARDING FEDERALLY SPONSORED RESEARCH OR DEVELOPMENT

This invention was made with government support under grant number 2240554 awarded by the National Science Foundation. The government has certain rights in the invention.

### BACKGROUND

Structural color is not based on standard pigments or dyes but, rather, can arise from light interaction with alternating stacks of dissimilar materials with contrasting optical characteristics. The optical qualities that result in the heterostructure depend on each block's thickness and optical properties (i.e. refractive index, extinction coefficient). Reflected light combines through constructive and/or destructive interference, resulting in an observed color. However, it is difficult to control structures to meet the required length scales.

MXenes are hydrophilic, 2-dimensional materials with high electrical conductivity, and adjustable band gap, and high zeta-potential that possess unique optical characteristics, but it is exceedingly challenging to control the thickness of MXene blocks on the length scales required to achieve structural color (nanometers to tens or hundreds of nanometers thick). In past studies, MXenes have been primarily used as a base to amplify the structural colors of the materials (e.g. SiO₂) deposited on top of a layer of MXene nanosheets.

Despite advances in structural color research, there is still a scarcity of methods for producing structural color that are easily controlled to produce structures on the required nanolength scales. It would be desirable to develop a system and method for producing structural colors with carefully-controlled layer thicknesses and tunable color properties. It would further be desirable for MXenes to be integrated into a heterostructure architecture via layer by layer (LbL) assembly—eliminating the need to incorporate other nanostructured materials (e.g., SiO₂) to achieve the desired structured color behavior with a lower overall thickness. It would further be desirable for the color to resist fading as long as the structure is intact. These needs and other needs are satisfied by the present disclosure.

### SUMMARY

Disclosed herein are systems and methods for producing structural color in layer-by-layer assemblies of Ti₃C₂T_{z} MXene nanosheets and polyelectrolyte heterostructures with controlled block thicknesses. In an aspect, the block thickness and spatial placement of MXene is controlled by the assembly's salt concentration and number of layer pairs. In a further aspect, to achieve controllable thicknesses in MXene blocks a processing method called layer-by-layer (LbL) assembly is employed. LbL assembly uses electrostatic interactions to alternately deposited layers of desired materials. In a still further aspect, layers of desired thicknesses can be built up by sequential deposition, allowing the creation of MXene blocks of specific thicknesses in order to attain structural color.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1F show various representations of the morphology of the LbL heterostructures. FIG. 1A: Schematic of the block and layer pair makeup for the heterostructures. FIG. 1B: Cross-sectional SEM image of a [(PDADMA/Ti₃C₂T_{z})₂/(PDADMA/PSS)₂]_{8.5} assembled with 1.0 M NaCl in block B. FIG. 1C: AFM surface morphology of an LbL heterostructure, [(PDADMA/Ti₃C₂T_{z})₂/(PDADMA/PSS)₂]ₓ with 0.5 M NaCl in block B, where a MXene layer from block A is the outermost layer (left) and where PSS from block B is the outermost layer (right).

FIGS. 1D-1F TEM images of varying magnifications of a [(PDADMA/Ti₃C₂T_{z})₂/(PDADMA/PSS)₂]_{8.5} assembled with 0.5 M NaCl in block B. The orange line demarcates the platinum surface coating deposited to reduce charging, and the blue line demarcates the Si substrate. The material between the orange and blue lines represents the heterostructure cross section. The chartreuse brackets highlight darker regions attributed to MXene-rich block A, and the pink brackets highlight lighter regions attributed to polymer-rich block B.

FIGS. 2A-2F show growth rate comparisons and appearance of heterostructures 0.5 M NaCl vs 1.0 M NaCl in block B. FIG. 2A: UV-Vis absorbance and (FIG. 2B) thickness of [(PDADMA/Ti₃C₂T_{z})₂/(PDADMA/PSS)₂]ₓ heterostructures with either 0.5 M NaCl or 1.0 M NaCl in block B. Digital photographs of [(PDADMA/Ti₃C₂T_{z})₂/(PDADMA/PSS)₂]ₓ with 0.5 M NaCl in block B heterostructures at various “x”/LbL cycles on (FIG. 2C) glass and (FIG. 2D) Si substrates. Digital photographs of [(PDADMA/Ti₃C₂T_{z})₂/(PDADMA/PSS)₂]ₓ with 1.0 M NaCl in block B heterostructures at various “x”/LbL cycles on (FIG. 2E) glass and (FIG. 2F) Si substrates.

FIGS. 3A-3D show growth rate comparisons and appearance of heterostructures 2 LP block B vs 4 LP block B. FIG. 3A: UV-Vis absorbance and (FIG. 3B) thickness of [(PDADMA/Ti₃C₂T_{z})₂/(PDADMA/PSS)ₘ]ₓ heterostructures with 0.5 M NaCl in block B. Digital photographs of [(PDADMA/Ti₃C₂T_{z})₂/(PDADMA/PSS)₄]ₓ with 0.5 M NaCl in block B heterostructures at various x/LbL cycles on (FIG. 3C) glass and (FIG. 3D) Si substrates. Digital photographs of [(PDADMA/Ti₃C₂T_{z})₂/(PDADMA/PSS)₂]ₓ with 0.5 M NaCl heterostructures (the case of m=2) are provided in FIGS. 2C-2D.

FIGS. 4A-4C show reflectance spectra of various n for each heterostructure system. FIG. 4A: [(PDADMA/Ti₃C₂T_{z})₂/(PDADMA/PSS)₂]ₓ with 1.0 M NaCl in block B, (FIG. 4B) [(PDADMA/Ti₃C₂T_{z})₂/(PDADMA/PSS)₂]ₓ with 0.5 M NaCl in block B, and (FIG. 4C) [(PDADMA/Ti₃C₂T_{z})₂/(PDADMA/PSS)₄]ₓ with 0.5 M NaCl in block B heterostructures.

FIG. 5 shows a bar chart displaying the reflectance peak wavelength for 0°, 15°, and 30° (from sample normal) incident angles of light for [(PDADMA/Ti₃C₂T_{z})₂/(PDADMA/PSS)₂]_{8.5} with 0.5 M NaCl in block B (left), [(PDADMA/Ti₃C₂T_{z})₂/(PDADMA/PSS)₂]_{8.5} with 1.0 M NaCl in block B (center), and [(PDADMA/Ti₃C₂T_{z})₂/(PDADMA/PSS)₄]_{4.5} with 0.5 M NaCl in block B (right) heterostructures.

FIGS. 6A-6C show CIE 1931 color space plots of structural color of heterostructures. CIE 1931 color space plots of structural color of heterostructures. Colors of heterostructures with x as indicated plotted in CIE 1931 color space next to photo of films on Si wafer; (FIG. 6A) [(PDADMA/Ti₃C₂T_{z})₂/(PDADMA/PSS)₂]ₓ with 0.5 M NaCl in block B, (FIG. 6B) [(PDADMA/Ti₃C₂T_{z})₂/(PDADMA/PSS)₂]ₓ with 1.0 M NaCl in block B, and (FIG. 6C) [(PDADMA/Ti₃C₂T_{z})₂/(PDADMA/PSS)₄]ₓ with 0.5 M NaCl in block B heterostructures.

FIGS. 7A-7C show complex refractive index variables n and k for heterostructure blocks and computational reflectance spectra. FIG. 7A: MXene-rich block A and (FIG. 7B) polymer-rich block B refractive indices measured using spectroscopic ellipsometry. FIG. 7C: Experimental (cyan line) and OpenFilters-generated (magenta line) reflectance spectra of the [(PDADMA/Ti₃C₂T_{z})₂/(PDADMA/PSS)₄]_{2.5} heterostructure with 0.5 M NaCl in block B.

FIGS. 8A-8C show absorbance spectra of various x of (FIG. 8A) [(PDADMA/Ti₃C₂T_{z})₂/(PDADMA/PSS)₂]ₓ with 1.0 M NaCl in block B, (FIG. 8B) [(PDADMA/Ti₃C₂T_{z})₂/(PDADMA/PSS)₂]ₓ with 0.5 M NaCl in block B, and (FIG. 8C) [(PDADMA/Ti₃C₂T_{z})₂/(PDADMA/PSS)₄]ₓ with 0.5 M NaCl in block B heterostructures. When x ends in 0.5, this corresponds to the MXene-rich block being on top of the heterostructure.

FIG. 9 shows OpenFilters generated reflectance spectrum model for the [(PDADMA/Ti₃C₂T_{z})₂/(PDADMA/PSS)₄]_{2.5} heterostructure with 0.5 M NaCl in block B without the use of a refractive index multiplier constant (top). OpenFilters generated reflectance spectrum model for the [(PDADMA/Ti₃C₂T_{z})₂/(PDADMA/PSS)₄]_{3.5} heterostructure with 0.5 M NaCl in block B with the use of the model parameters determined by the fitting of the heterostructure with 0.5 M NaCl in block B (bottom).

FIG. 10 shows [(PDADMA/Ti₃C₂T_{z})₂/(PDADMA/PSS)₂]ₓ heterostructure with 0.5 M NaCl in block B, where x=8.5 (left) and x=10.5 (right) on polyethylene terephthalate substrates.

FIGS. 11A-11D show characterization of Ti₃C₂Tx nanosheets, (FIG. 11A) XRD spectrum of the vacuum-assisted filtered film, (FIG. 11B) AFM image of drop-cast dispersion (inset shows height profile of the Ti₃C₂Tx nanosheet denoted by the white line), (FIG. 11C) XPS survey spectrum of vacuum-assisted filtered film, (FIG. 11D) high resolution and deconvoluted Ti 2p XPS spectrum of vacuum-assisted filtered film.

FIGS. 12A-12G show humidity sensing using. MXene LbL heterostructures. (FIG. 12A) Schematic displaying the block and LP makeup of the heterostructure. (FIG. 12B) Digital image and (FIG. 12C) UV-visible spectrophotometric reflectance, transmittance, and absorptance spectra of the heterostructure. (FIGS. 12D and 12F) Digital photographs showing the color change of the heterostructure with increasing RH (0% to 80% RH in 10% increments from left to right). (FIGS. 12E and 12G) Normalized resistance of the heterostructure with changing humidity.

FIGS. 13A-13F show a non-spectral magenta heterostructure. (FIG. 13A) Digital photograph of [(PDADMA/Ti₃C₂T_{z})_{y}/(PDADMA/PSS)ₘ]₃ heterostructure, where y and m correspond to the number of LPs for each block detailed in the accompanying table. (FIG. 13B) UV-visible spectrophotometric optical spectra and (FIG. 13C) angle-variant specular reflectance of the heterostructure. (FIG. 13D) Red and blue reflectance peaks from FIG. 13C with angle. FIG. 13E shows percent reflectance, while FIG. 13F shows percent transmittance. For transmittance, the response is largely specular, resulting in a translucent surface rather than a hazy one. Diffuse reflectance dominance is seen in most of the visible range. While the blue peak is more diffuse R, the red peak is more slightly specular R. Thus, the heterostructure is not as glossy as the indigo heterostructure (see FIGS. 16A-16C) nor is it as matte as the green heterostructure (see FIGS. 15A-15C).

FIG. 14 shows cross-sectional TEM images and EDS mapping showing Ti for (top) indigo, green, and cyan heterostructured LbL coatings.

FIGS. 15A-15C show creation of a green heterostructure including reflectance values, layer structure, and a photograph of the completed film.

FIGS. 16A-16C show creation of an indigo heterostructure including reflectance values, layer structure, and a photograph of the completed film.

FIGS. 17A-17C show angle dependency of structural color for a green heterostructure (FIG. 17A), an indigo heterostructure (FIG. 17B), and a pink/magenta heterostructure (FIG. 17C).

FIGS. 18A-18B show specular versus diffuse reflectance and transmittance for the indigo heterostructure. For both R and T, a mainly specular response was observed with some exceptions in select regions of the R spectrum. A specular R peak at 441 is responsible for the glossy appearance of the heterostructure, while specular T dominance throughout the visual range results in a translucent rather than hazy appearance.

FIGS. 19A-19B show specular versus diffuse reflectance and transmittance for the green heterostructure. For T, a mainly specular response is observed, resulting in a translucent rather than hazy appearance. Diffuse D dominates in the visible range, resulting in a matte appearance. Surface/interlayer roughness or subsurface scattering may be higher compared to the indigo heterostructure.

FIGS. 20A-20D show s-plane and p-plane polarized variable angle resistance for the indigo structure (see FIGS. 16A-16C).

FIG. 21 shows the [(PDADMA/Ti₃C₂T_{z})₃/(PDADMA/PSS)₉]_{2.5} LbL heterostructure coated on a variety of different substrates including an Si wafer, polyethylene terephthalate, polyvinyl chloride, polydimethylsiloxane, Dragon Skin™ silicone, white nylon string, and quartz crystal.

FIGS. 22A-22B show photographs and layer descriptions of two heterostructures on which humidity tests were performed.

FIG. 23 shows change in mass with change in relative humidity for an exemplary blue heterostructure as described herein.

FIG. 24 shows change in mass with change in relative humidity for an exemplary pink heterostructure as described herein.

FIGS. 25A-25B show mass change over 25 cycles between 10% and 60% RH for blue (FIG. 25A) and pink (FIG. 25B) heterostructures.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Two-dimensional (2D) transition metal carbides and nitrides (MXenes) have generated significant interest due to their potential use in electronics, optics, and robotics. MXenes follow the chemical formula of Mₙ₊₁XₙT_{z}, where M is a transition metal, X is carbon and/or nitrogen, T represents a surface terminal group, z is the number of terminal groups, and n is a number 1-42. MXenes are known to offer a variety of desirable properties involving conductivity, hydrophilicity, and optical absorption. Studies into the optical response of MXenes show that the intra- and interband transitions control the dielectric constant based on the terminal groups of the MXene. Overall, Ti₃C₂T_{z} MXenes possess a high absorption coefficient throughout the UV, visible, and infrared ranges (i.e., anomalous dispersion at most wavelengths). Despite exhibiting appealing material characteristics, MXene nanosheets often have the propensity to restack (i.e., clump together via van der Waals forces and hydrogen bonding after exfoliation), which impedes control over the MXene's nanostructure and can complicate subsequent material processing (e.g., into large-scale thin films and optical coatings).

Layer-by-layer (LbL) assembly potentially offers a means to control the spacing between MXene layers by depositing negatively charged MXene in a defined sequence with a complementary material (e.g., a polyelectrolyte). Using this approach, the resulting LbL assembly is stabilized by electrostatic attraction between the alternating positively charged and negatively charged layers. Prior work has demonstrated MXene-containing LbL structures, including but not limited to, polydiallyldimethylammonium (PDADMA)/Ti₃C₂T_{z} films for humidity and pH sensors, silane-functionalized Ti₃C₂T_{z}/Ti₃C₂T_{z} films with improved conductivity, and nanomaterial/Ti₃C₂T_{z} coated electrodes. LbL assembly is surface-agnostic in that coatings can be created on a variety of substrates (e.g., glass, fabric, carbon, nanoparticles, Teflon) using an assortment of materials (e.g., nanomaterials, polyelectrolytes). LbL assembly also allows for nanometer-level control layer thicknesses, which can be tuned based on the material composition, deposition time, and method (e.g., dip-, spray-, spin-coating), and pH of solutions. For example, layer pairs (LPs) within LbL assembled films have been as thin as 2 nm and up to hundreds of nanometers in thickness.

LbL assembly is promising for preparing optical coatings because the technique allows for precise control of each layer's thickness and chemistry, yielding multilayer heterostructures for optical filters such as Bragg reflectors, omnidirectional absorbers, and gradient-index rugate filters. For example, Puzzo et al. fabricated distributed Bragg reflectors from several material combinations of SiO₂, TiO₂, SnO₂, and Sb:SnO₂ nanoparticles. Layer thicknesses varied from 60 nm to 287 nm, depending on the nanoparticle composition. The effective refractive index contrasts of the alternating material layers varied from 0.03 to 0.59, demonstrating different peak reflection intensities at visible wavelengths. Additionally, the reflected color was shown to differ with respect to changes in the reflection peak location. The observed coloration in these heterostructures stems from the phenomenon of structured color. Such color generation at visible wavelengths is due to light interactions within the structured nanoarchitecture (e.g., nanomaterial size, dimension, and geometry or aspect ratio in relation to the heterostructure architecture), rather than the use of organic pigments or dyes that absorb/reflect light of specific wavelengths based on the molecular composition and bonding configuration. Optical coatings and devices that make use of structural coloration do so by controlling the optical properties (i.e., the refractive index, n, and extinction coefficient, k) of the respective material layers and layer thicknesses. To date, MXene nanosheets have not been incorporated into LbL assemblies for structural color applications.

In past studies, MXenes have been primarily used as a base to amplify the structural colors of the materials above (e.g., SiO₂ nanoparticles). For example, Xue et al. used blade-coated Ti₃C₂T_{z} MXene on a substrate to create a black background beneath layers of SiO₂ nanoparticles. Li et al. used MXenes as a support for the actuation of polystyrene photonic crystals. Similarly, Bian et al. used MXenes as a support for bioinformation coding leveraging SiO₂-dopamine photonic crystals. Zhang et al. also used MXene as a black background for soft photonic crystals with electrochromic applications. In each of these past works, MXenes did not contribute to the structural coloration itself; instead other photonic crystal materials were utilized.

Herein, it has been shown that MXenes can be integrated into a heterostructure architecture via LbL assembly-potentially eliminating the need to incorporate other nanostructured materials (e.g., SiO₂) to achieve the desired structured color behavior. Specifically, it is reported that the LbL assembly of MXene/polyelectrolyte heterostructures using two different cation/anion LP sets (or blocks). These blocks are composed of PDADMA/Ti₃C₂T_{z} MXene and PDADMA/polystyrene sulfonate (PSS). PDADMA/PSS LbL multilayers have been previously studied and well characterized, allowing a focus on how the inclusion of the MXene-rich block contributes to the heterostructure's structural color. Adjustments to the PDADMA/PSS block are made through varying salt concentration and number of layer pairs. This allows for the thickness of the PDADMA/PSS block to differ, thus altering the thickness between MXene-rich blocks. The impact of this spacing on the optical response is investigated, including structural color. The film morphologies and growth rates are also studied to demonstrate the potential range of control afforded by the LbL assembly technique. This study opens the door for LbL MXene-polymer configurations that can yield tailored wavelength-dependent optical performance (e.g., reflection, transmission, and absorptance) optical coatings for applications in actuation, thermal camouflage, and bioinformation coding.

In one aspect, disclosed herein is structurally-colored heterostructure including a substrate and a plurality of pairs of blocks, wherein each pair of blocks includes a first block and a second block, wherein the first block includes at least an MXene, and wherein the second block includes solely polyelectrolytes. In another aspect, the MXene follow the formula of Mₙ₊₁XₙT_{z}, where M is a transition metal, X is carbon and/or nitrogen, n is an integer 1-4, and T_{z} represents one or more terminal groups selected from —OH, —COOH, —O, —F, or any combination thereof. Some examples of MXenes include, but are not limited to, Ti₃C₂T_{z}, Ti₂CT_{z}, V₂CT_{z}, Ti₄N₃T_{z}, Ti₃CNT_{z}, Ti₂NT_{z}, Nb₂CT_{z}, Mo₂CT_{z}, and the like. In another aspect, the polyelectrolyte can include a polycation, a polyanion, or both. In one aspect, the polycation can be selected from polydiallyldimethylammonium (PDADMA), polyethyleneimine, polyethylene oxide, polyallylamine hydrochloride, polyaniline, poly(vinylamine), chitosan, glutaraldehyde, or any combination thereof, while the polyanion can be selected from polystyrene sulfonate (PSS), polyacrylic acid, polymethacrylic acid, polyethylene glycol, poly(2-acrylamido-2-methyl-1-propanesulfonic acid), polyvinylpyrrolidone, poly(N-isopropylacrylamide)-co-acrylic acid, polyacrylamide, or any combination thereof. In some aspects, the first block and the second block both include a polycation, wherein the polycation is the same or different for each block. Further in this aspect, the polycation can be PDADMA. In another aspect, either or both of the first block and the second block can contain a salt such as, for example, NaCl. Further in this aspect, when the first block and the second block both contain the salt, both can contain the same amount of the salt or each can contain a different amount of the salt. In one aspect, the first block can be polydiallyldimethylammonium (PDADMA)/Ti₃C₂T_{z} and the second block can be PDADMA/polystyrene sulfonate (PSS). However, other compositions are contemplated and should be considered disclosed.

In one aspect, the disclosed materials do not fade as long as the structure remains intact.

In another aspect, each first block and each second block include one or more layers of material. In a further aspect, the thicknesses of the layers can be the same or different. In another aspect, each of the plurality of pairs of blocks can be the same or different. Further in this aspect, each of the plurality of pairs of blocks can vary in one or more of pH used during deposition, salt (electrolyte), number of cycles of layer deposition, length of time of deposition, MXene/polyelectrolyte identity. In one aspect, variation of these parameters enables tunability of the heterostructures to achieve specific colors. In another aspect, the substrate can be selected from glass, coated glass, silicon dioxide, a silicon wafer, a Ti/Au quartz crystal substrate, various fibers/fabric, polymer/plastic, metal, or any combination thereof. In one aspect, the layers can be as thin as 1 nm each.

In an aspect, the color of the structurally-colored heterostructure appears identical to a standard observer independent of an angle of observation (i.e., can be described using the same coordinates in the CIE 1931 color space or another color space). In another aspect, the wavelength reflected from the structurally-colored heterostructure is identical independent regardless of an angle of measurement. In an alternative aspect, the color of the structurally-colored heterostructure can be angle dependent; that is, a standard observer would view different colors (as described by the CIE 1931 color space or another color space) from different angles of observation, or a wavelength measured from different angles would be different.

Also disclosed herein are articles including the disclosed structurally-colored heterostructures. In one aspect, the article can be a Bragg reflector, an optical coating, a dielectric mirror, an optical limiting material, a humidity sensing device, a textile material, or any combination thereof. In some aspects, the articles may be particularly useful in directed energy applications and defense applications.

In yet another aspect, disclosed herein is a method for making the disclosed structurally-colored heterostructures, the method including layer-by-layer (LbL) deposition of materials making up each layer of each of the plurality of blocks. In some aspects, the LbL deposition can be performed in a solution of from about 0.5 M NaCl to about 1.0 M NaCl.

Also disclosed are applications in sensing, anti-counterfeiting, smart displays and/or smart materials, and biomimetic devices using the disclosed materials. In another aspect, disclosed herein is a method for sensing humidity using the structurally-colored heterostructures described herein, the method including at least the steps of:
(a) measuring at least one physical quantity selected from color according to CIE 1931 color space, reflected wavelength, electrical resistance, or mass a first time;
(b) placing the structurally-colored heterostructure in an environment of unknown humidity;
(c) measuring the at least one physical quantity a second time; and
(d) comparing a change in the at least one physical quantity to a calibration curve for the structurally-colored heterostructure to determine humidity of the environment.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a polyelectrolyte,” “a polymer,” or “an MXene,” include, but are not limited to, mixtures or combinations of two or more such polyelectrolytes, polymers, or MXenes, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of an MXene refers to an amount that is sufficient to achieve the desired improvement in the property modulated by the component. The specific level in terms of wt % in a composition required as an effective amount will depend upon a variety of factors including the amount and type of polymers used to form a composite with the MXene, whether the composite is to be used as a coating or a molded device, and location in the body in which a device including the composite is to be implanted.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Controlled Layer-by-Layer Assembly and Structured Coloration of Ti₃C₂T_{z} MXene/Polyelectrolyte Heterostructures

### Results and Discussion

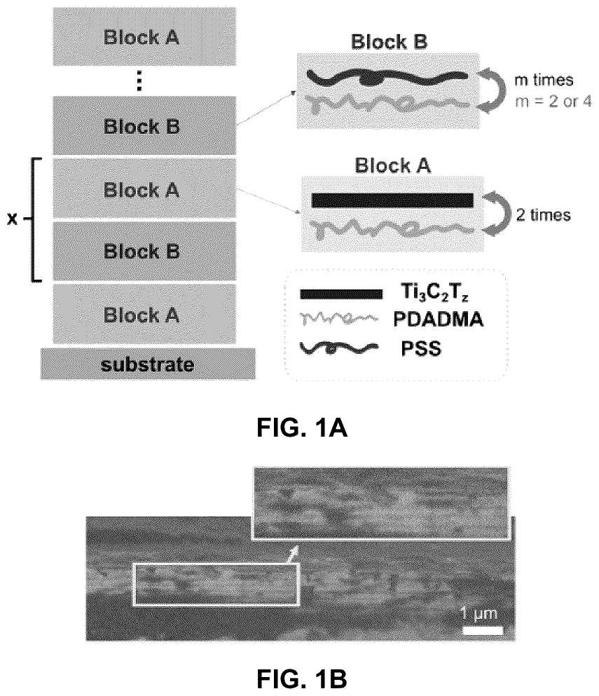

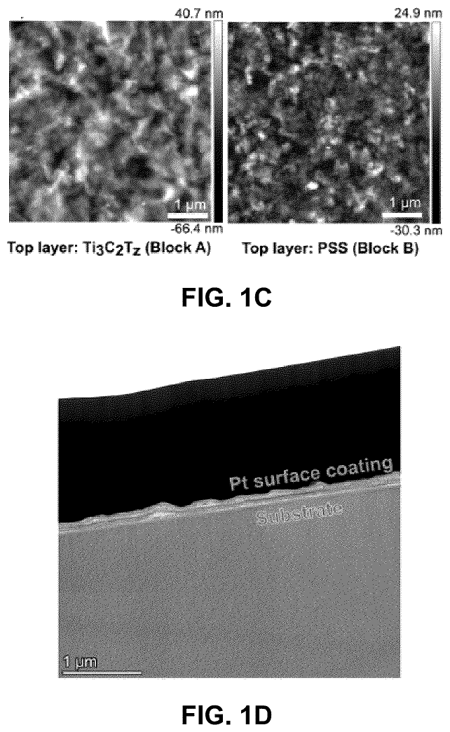

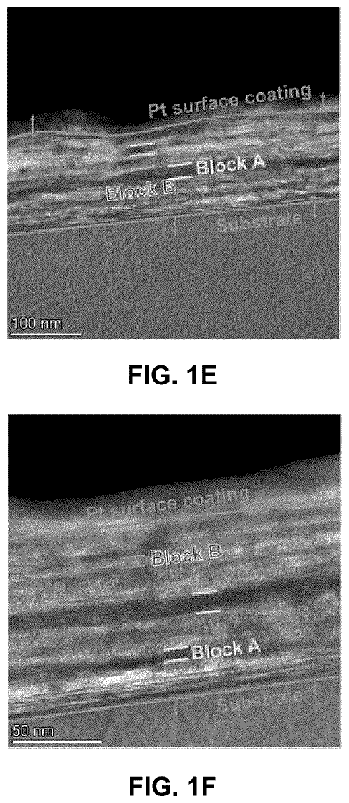

Three different compositions of LbL heterostructures were created to demonstrate control of the different block thicknesses. FIG. 1A shows a schematic of the LbL films, where different sequences of LbL assembly are performed in blocks to create distinct repeating sections. Block A was composed of two LPs of PDADMA/Ti₃C₂T_{z}, and block B was composed of either two or four LPs of PDADMA/PSS assembled at 0.5 M NaCl. In a third set, block B contained two LPs of PDADMA/PSS assembled at 1.0 M NaCl. In all three sets, blocks of A and B were alternated “x” times to create heterostructures of various block pairs. As nomenclature, the LbL films are denoted as [(PDADMA/Ti₃C₂T_{z})₂/(PDADMA/PSS)ₘ]ₓ where the materials for each block are within parentheses, followed by a subscript that represents the number of layer pairs in said block. The “m” subscript following the PDADMA/PSS block will either be a 2 or 4, depending on the heterostructure system, while the “x” subscript following the end bracket represents the number of times the block pairs were repeated. If this value ends in 0.5, this means that the PDADMA/Ti₃C₂T_{z} block is on top of the heterostructure. For block A, citric acid was added to the assembly solutions to prevent MXene oxidation. These three different LbL systems allowed analysis of how changing the spacing between the MXene containing blocks, through varying the thickness of polymer-rich block B, affected the heterostructure's growth and optical properties. Each composition was made at least three times, and then the data were compiled and statistically analyzed.

Cross-sectional scanning electron microscopy (SEM) was performed to confirm the presence of the alternating blocks. Due to the thin blocks and the presence of polymer within the heterostructure, SEM imaging at high magnifications was difficult because of film charging. Films were freeze-fractured to produce a cleaner cross-sectional cut. The SEM image in FIG. 1B shows a cross-section of a [(PDADMA/Ti₃C₂T_{z})₂/(PDADMA/PSS)₂]_{8.5} with 1.0 M NaCl in block B. The alternating layers of light and dark gray indicate the successful creation of a heterostructure morphology. The light gray areas correspond to the polymer-rich block B, and the dark gray areas correspond to MXene-rich block A. In the magnified inset, pieces of MXene nanosheet appear to protrude from the film, which is attributed to the sample preparation. Overall, FIG. 1B presents a representative morphology in which the other LbL systems investigated show a layered or “blocky” structure, see below.

Topographic scans were performed using atomic force microscopy (AFM) to compare the surface morphology of the terminating layers. FIG. 1C left shows a topographical scan of an LbL heterostructure in which MXene nanosheets were the last material deposited. The observed wrinkling is a result of overlapping MXene nanosheets that lay atop one another. The sheets themselves were about 0.5 to 3.5 μm in lateral size, which is on the order of the wrinkle's features. FIG. 1C right shows a similar scan in which PSS was the last material deposited. Similar to FIG. 1C left, the surface presents a wrinkled morphology over the area scanned (10×10 μm²). The roughnesses were comparable at 5.48 nm for when MXene was the last layer and 5.50 nm for when PSS was outermost. This result indicates that each layer deposits uniformly over one another and preserves the surface texture of the block or layer just beneath it.

Transmission electron microscopy (TEM) provides cross-sectional images of heterostructure morphology. FIGS. 1D-1F display distinct stripe-like layering in the LbL assembly, consistent with the layering observed in SEM images (FIG. 1B). The darker gray layers, as highlighted by the chartreuse brackets in FIGS. 1D-1F, are assigned to MXene-rich block A, or blocks of PDADMA/Ti₃C₂T_{z}. Notably within FIG. 1F, block A shows thin, dark striations that are consistent with individual MXene nanosheet layers. The lighter gray areas, as highlighted by the pink brackets, depict the polyelectrolyte-rich block B sections. The cross-sectional TEM images were performed on heterostructures of [(PDADMA/Ti₃C₂T_{z})₂/(PDADMA/PSS)₂]_{8.5}, which alternatingly consist of 9 blocks of A and 8 blocks of B. However, due to processing of the sample using focused ion beam (FIB) milling, some of the sections may have become damaged, preventing a clear discernment of the 9 blocks of A. Specifically, polymer layers mill at a faster rate than MXene in FIB processing, possibly causing imperfections in the cross-section.

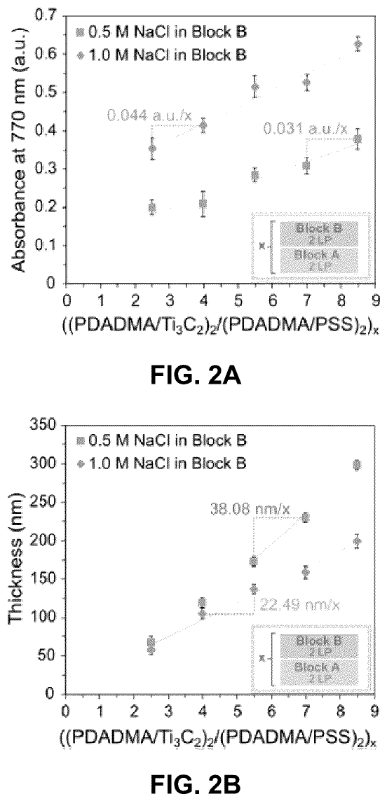

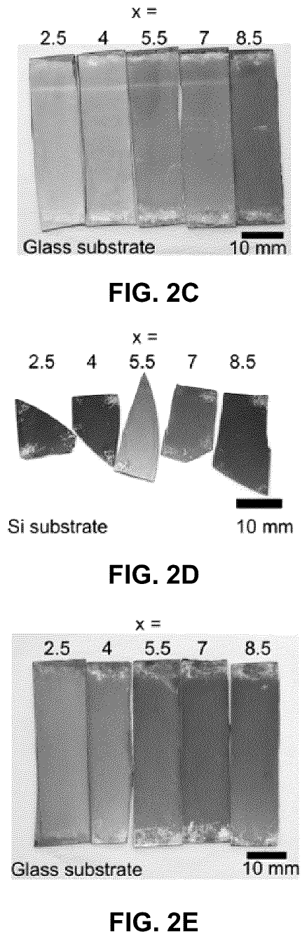

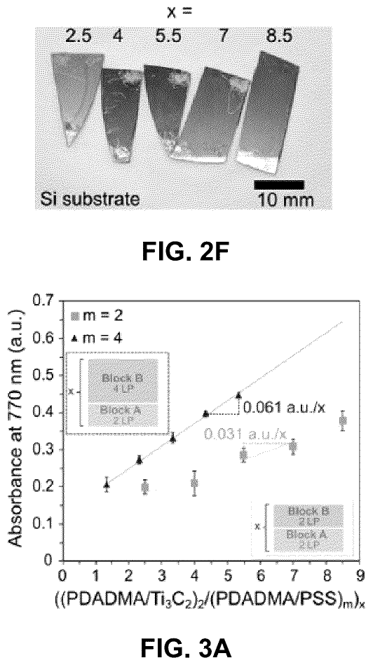

Using UV-Visible (UV-Vis) spectroscopic absorbance and profilometry, the growth profiles of two heterostructures were compared for varying concentrations of NaCl during the assembly of block B. Specifically, [(PDADMA/Ti₃C₂T_{z})₂/(PDADMA/PSS)₂]ₓ heterostructures in which either 0.5 M or 1.0 M NaCl was added to the solutions and washes for the PDADMA/PSS sections of the heterostructure (block B) were compared. The absorbance growth profile was constructed based on the UV-Vis absorbance reading at 770 nm, attributed to the broad adsorption feature of the MXene nanosheets. The higher the absorbance, the darker the film will appear. Within all growth profiles, a linear relationship was obtained, as expected, but heterostructures with 1.0 NaCl in block B were notably darker. Specifically, heterostructures that contained 0.5 M NaCl within block B presented an average absorbance growth of 0.031 a.u. per x (FIG. 2A), and those with 1.0 M NaCl in block B presented a slightly larger average absorbance growth of 0.044 a.u. per x at 770 nm. From profilometric thickness measurements, heterostructures with 0.5 M NaCl in block B grew an average thickness 38.1 nm per x (FIG. 2B), and those with 1.0 M NaCl in block B grew an average thickness 22.5 nm per x. As will be described below, the differences in absorbance and thickness are attributed to different levels of MXene adsorption and multilayer growth.

Interestingly, the heterostructures displayed different colors depending on both the number of block pairs and on the salt concentration in block B, FIGS. 2C-2F. The heterostructure-coated glass substrates clearly show this change in hue as x increases, particularly for the set containing 1.0 M NaCl in block B (FIG. 2E). To examine if these colors were a result of thickness-based film interference, the colors and thickness of certain samples were compared against each other. For example, two samples of similar deep orange/brown color resulted from two different heterostructures of different thicknesses (67 nm thick [(PDADMA/Ti₃C₂T_{z})₂/(PDADMA/PSS)₂]_{2.5} heterostructures with 0.5 M NaCl vs 105 nm thick versus [(PDADMA/Ti₃C₂T_{z})₂/(PDADMA/PSS)₂]4 heterostructures with 1.0 M NaCl), shown in FIGS. 2D and 2F. In another comparison, two different heterostructures of similar thicknesses of 67 and 57 nm displayed different colors of orange/brown and gold ([(PDADMA/Ti₃C₂T_{z})₂/(PDADMA/PSS)₂]_{2.5} heterostructure with 0.5 M NaCl in block B versus [(PDADMA/Ti₃C₂T_{z})₂/(PDADMA/PSS)₂]_{2.5} heterostructure with 1.0 M NaCl in block B, respectively). A report by Yu et al. on colors arising from thickness-based thin film interference of PDADMA/PSS multilayers provides a useful comparison. First, Yu et al. were not able to create the brownish color that matched the disclosed heterostructures. Second, Yu et al. observed yellow coloring for a 250 nm thick PDADMA/PSS multilayer, and a yellow/chartreuse color was observed for the disclosed 135 nm thick heterostructure. With these observations, it is hypothesized that the color of the disclosed heterostructures is not solely based on thickness-based thin film interference, but instead arises from a different mechanism of structural color.

The differences in UV-Vis absorbance and growth profiles between the two heterostructures can be explained by examining their relative MXene compositions. To determine the composition of the hetero-structures, a quartz crystal microbalance (QCM) was used to estimate the areal mass deposited with each block. For the heterostructures that contained 0.5 M NaCl in block B, the areal mass for block A was 4.70 μg/cm², and the areal mass for block B was 3.00 μg/cm². This results in a hetero-structure composition of 61 wt % block A and 39 wt % block B. Assuming that the block A contains 90 wt % Ti₃C₂T_{z}, it is deduced that the entire heterostructure contains 54.9 wt % MXene. Using the assumption that the average thickness of a MXene nanosheet has a thickness of 1 nm, it is estimated that for every block A section, there are approximately 11 MXene nanosheets stacked in a block. This result indicates that an individual MXene deposition step results in not one monolayer but multiple layers of adsorbed MXene sheets. In comparison, the heterostructures containing 1.0 M NaCl in block B had an areal mass of 7.80 μg/cm² for block A and an areal mass of 3.72 μg/cm² block B. This results in a heterostructure composition of 68 wt % block A and 32 wt % block B, leading to an overall MXene content of 61.2 wt % for the entire heterostructure. This also results in approximately 21 MXene nanosheets stacked in each block A.

From UV-Vis, profilometry, and QCM measurements (also summarized in Table 1), it is speculated that the film's growth mechanism is mediated by electrostatic interactions that compete between “normal” layer-by-layer deposition and partial desorption of the already adsorbed MXene sheets. The growth of block B, the PDADMA/PSS block assembled in either 0.5 M or 1.0 M NaCl, is first considered. Literature indicates that as the concentration of NaCl increases, so should the overall thickness of the PDADMA/PSS multilayer. Confirming this, it is observed that the areal mass for block B increased from 3.00 μg/cm² to 3.72 μg/cm² when salt concentration was increased from 0.5 M to 1.0 M. The thickness of MXene-rich block A, the PDADMA/MXene block assembled in 1 mg/mL citric acid with no added NaCl is next considered. Block A was thinner for the heterostructure that used 0.5 M NaCl in block B as compared to 1.0 M NaCl in block B. It is speculated that this is attributed to the stripping of loosely adhered MXene sheets when the heterostructure is exposed to PDADMA solutions in the subsequent polyelectrolyte-rich block B deposition. Specifically, electrostatic forces are relatively stronger at 0.5 M NaCl vs 1.0 M NaCl, such that PDADMA can interact with weakly adhered MXene sheets and strip them away from the multilayer. It is speculated that PDADMA then eventually deposits onto the heterostructure after all the poorly adhered MXene sheets are removed.

TABLE 1
Characteristics of the Different Heterostructures

| | | | |
|---|---|---|---|
| NaCl conc. (mol/L) in block B | 1.0 | 0.5 | 0.5 |
| Layer pairs in block B | 2 | 2 | 4 |
| Absorbance (a.u./x) | 0.044 | 0.031 | 0.061 |
| Thickness (nm/x) | 22.49 | 38.08 | 36.16 |
| Areal mass (μg/cm²) of block A | 7.80 | 4.70 | 9.91 |
| Areal mass (μg/cm²) of block B | 3.72 | 3.00 | 4.54 |
| Weight percentage block A | 68 | 61 | 69 |
| Weight percentage block B | 32 | 39 | 31 |
| MXene content (wt %) | 61.2 | 54.9 | 32.1 |
| # of MXene nanosheets (per block A) | 21 | 11 | 29 |
| Angle-independent structural coloration | No¹ | Yes | Yes |

¹Only the [(PDADMA/Ti₃C₂T_{z})₂/(PDADMA/PSS)₂]_{8.5} sample in this set does not show angle-independent structural coloration.

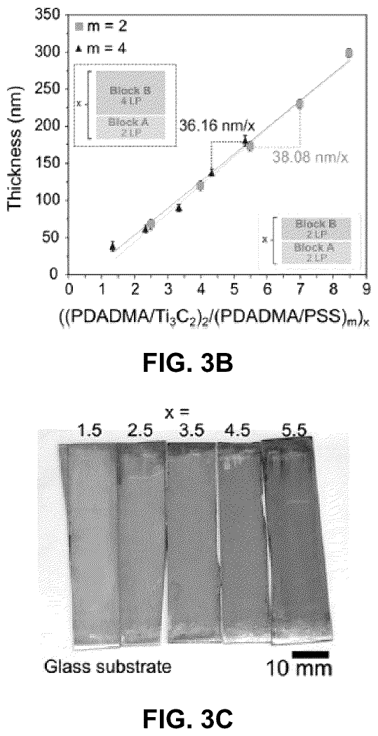

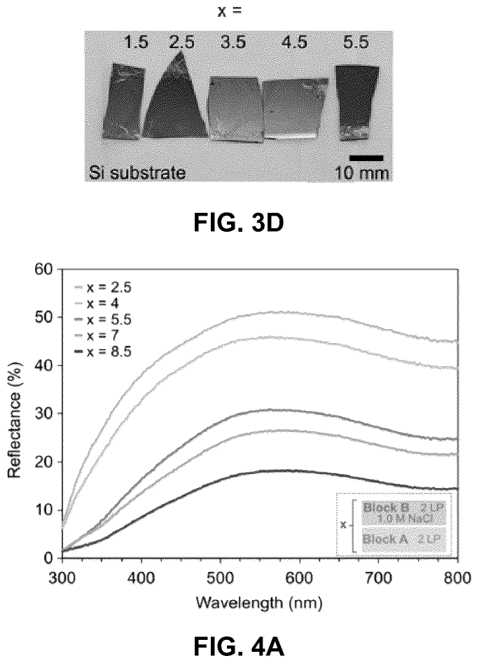

Similar to the prior comparison, the growth and appearance of two heterostructures with different numbers of LPs in polymer-rich block B were examined. Specifically, [(PDADMA/Ti₃C₂T_{z})₂/(PDADMA/PSS)ₘ]ₓ heterostructures in which 0.5 M NaCl was added to the solutions and washes for block B and m=2 or 4 were compared. It was expected that changing the m from two to four would increase the cycle thickness and would double the thickness of block B, thereby changing the distance between blocks of A. Instead, FIGS. 3A-3D show that changes in absorbance and appearance were attained, but the cycle thickness did not appreciably change. Specifically, for heterostructures in which m=2, the average absorbance growth of 0.031 a.u. per x (FIG. 3A), and those with m=4 presented a slightly larger average absorbance growth of 0.061 a.u. per n at 770 nm. As for the profilometric thickness, the average thickness per x was 38.1 nm for when block B had two layer pairs and 36.2 nm for four layer pairs, as seen in FIG. 3B. In other words, doubling the number of layer pairs in block B resulted in darker films with a similar growth rate.

As before, QCM was employed to determine the areal mass composition of each block in the heterostructure. For the case of m=4, the average areal mass deposited per blocks A and B were 9.91 μg/cm² and 4.54 μg/cm², respectively (or 69 wt % for block A and 31 wt % for block B), resulting in a MXene composition of 62.1 wt % of MXene in this heterostructure. This also corresponds to approximately 28 MXene nanosheets stacked for every block A section. These measured values were also summarized in Table 1. In comparison, the case of m=2 (described in the previous section) contained 54.9 wt % MXene. The higher mass fraction of MXene in the case of m=4 explains the heterostructures' higher absorbance growth rate and darker appearance. The areal mass, however, did not double upon increasing m from two to four (3.00 vs 4.54 μg/cm², respectively). The difference can be attributed to possible partial removal of the previous layers by stripping, as previously discussed. Also, for lower numbers of layer pairs, LbL growth is patchy, resulting in incomplete surface charge reversal. It is speculated that two layer pairs of block B results in patchy growth that might prevent the robust adhesion and adsorption of subsequent MXene layers. In comparison, four LPs of block A resulted in more robust MXene layer adsorption, leading to a larger MXene content.

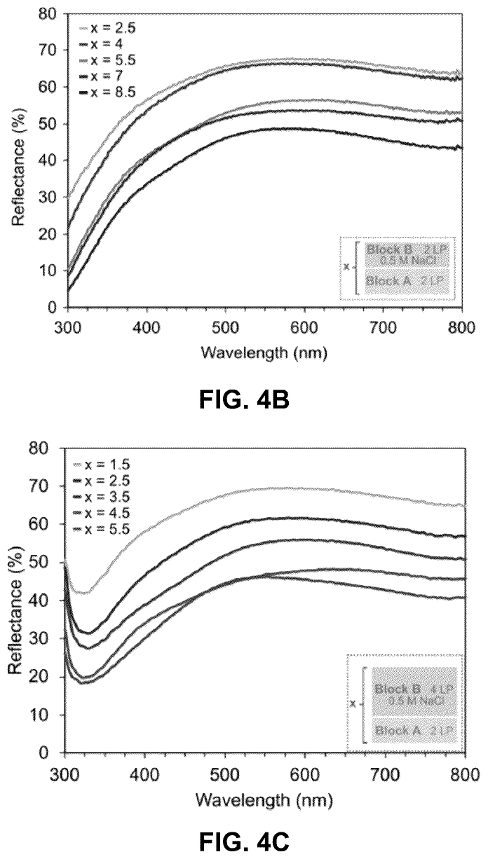

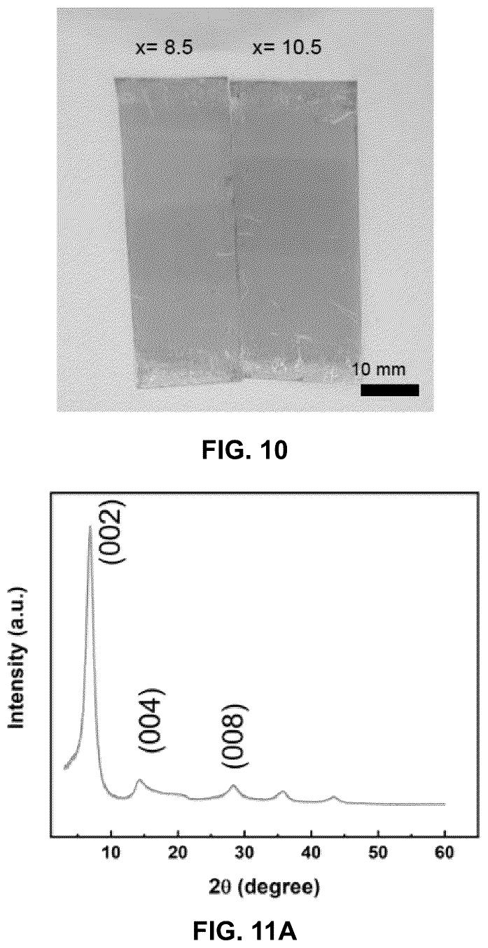

The heterostructures exhibited a range of colors as more layers were added, as seen in FIGS. 2C-2F and 3C-3D. Within the digital photographs, a difference in color richness was observed depending on the substrate for heterostructures of the same composition and layer pair number. As the overall thickness of the heterostructures was relatively thin, incident light transmitted through the films and interacted with the substrates. With the silicon substrate being more reflective than the glass substrate (and PET substrate in FIG. 10), the heterostructures on the silicon substrate appeared to have a richer color. The influence of the substrate was removed through filtering/baselining in subsequent UV-Vis measurements. Across all three heterostructures, it is observed that as the number of layer pairs increases the reflectance peak decreases (FIGS. 4A-4C). This layer-pair-dependent change in reflectance illustrates the opportunity to create a wide variety of optical coatings (e.g., mirrors, notch filters, induced transmission filters, or gradient-index lenses) with the same materials simply by varying layer thicknesses during the LbL assembly process. The drop in reflectance is due to an estimated increase in absorptance, as the relationship between reflectance (R), transmittance (T), and absorptance (A) is

$$1 = A + T + R \qquad ( 1 )$$

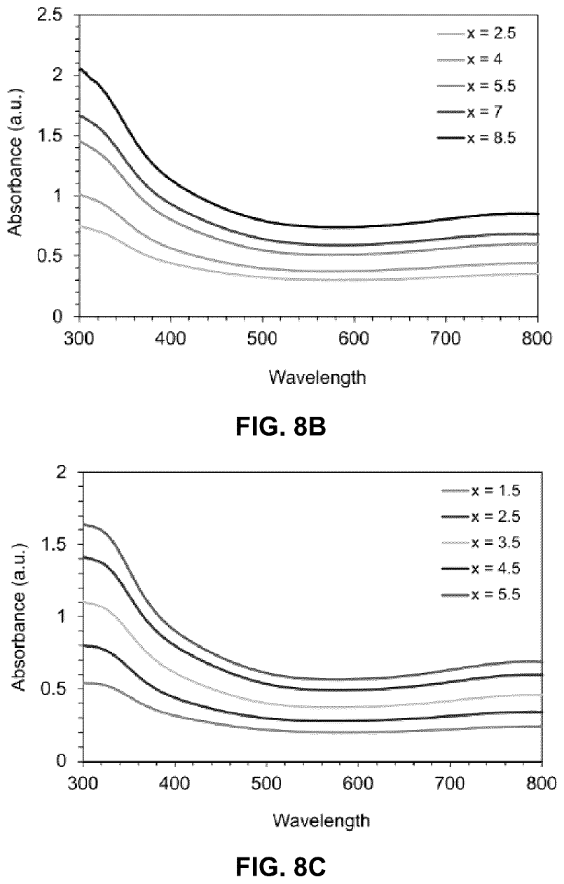

It is important to note that the absorbance values mentioned within the previous sections (and in FIGS. 8A-8C) do not carry the same definition as A in Eq. (1). Those absorbance values were the output of the UV-vis spectrophotometer, which relied on the presumed relationship between absorbance and transmittance used within the Beer-Lambert law. While literature often uses these terms interchangeably and both denoted by the variable “A”, they are not the same due to limitations made around the assumptions required by the Beer-Lambert law. The absorbance value from the Beer-Lambert law assumes light is not scattered, as in homogenous medium (e.g. solutions). However, the hetero-structures must scatter light, as confirmed by the presence of structural color. Yet, the use of said absorbance in previous sections was permitted as it was utilized to quantify heterostructure growth; but when directly dis-cussing the optical characteristics of the heterostructure, this value is no longer appropriate. To further avoid any issues in optical spectra analysis, the reflectance values in FIGS. 4A-4C were taken with a different UV-vis spectrophotometer (Hitachi U-4100 UV-Vis-NIR) that was capable of directly measuring reflectance as described in Eq. (1). This way the reflectance discussed throughout this section was independent of the absorbance values above.

The reflectance plots in FIGS. 4A-4C show broad peaks centered at wave-lengths dependent on the heterostructure composition and block thick-nesses. Within the set of heterostructures that contained 0.5 M NaCl in 2 LP thick block B, FIG. 4B, this peak shifted from being centered around ˜580 nm to ˜605 nm then back down to ˜570 nm, as the layer pairs increased. This peak shifting is also present in the set of heterostructures that contained 0.5 M NaCl in 4 LP thick block B, FIG. 4C; the peak center shifted from ˜575 nm to a max of ˜642 nm before dropping down to ˜550 nm. Unlike the other two compositions, the heterostructures containing 1.0 M NaCl in 2 LP thick block B, FIG. 4A, showed minimal peak shifting, generally staying centeredaround-565-575 nm. This film set also had lower reflectance values compared to the others.

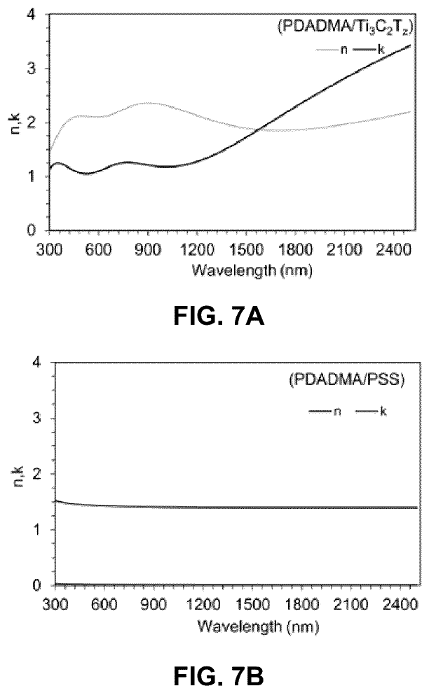

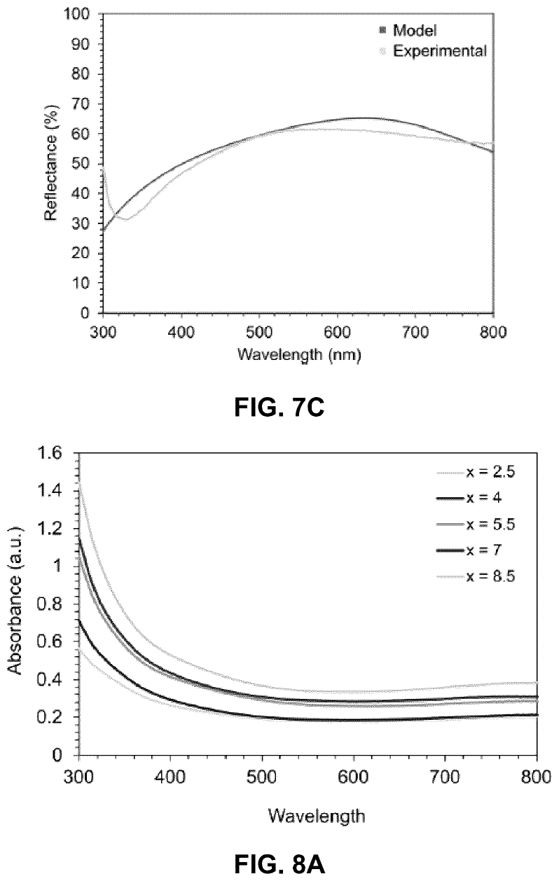

Notably, the reflectance spectra of all three heterostructures featured one broad peak within the selected wavelength range. This differs from films that yield structured color solely due to thin film interference, which normally exhibits a reflectance spectrum containing a periodic sinusoidal pattern. The presence of a sinusoidal pattern signature denotes that such films can be thought of as gradient-index homogenous blocks, rather than distinct multilayered heterostructures. Here, the lack of a sinusoidal pattern in the reflectance spectra for these heterostructures, along with the variant refractive indices/dielectric constants of the two blocks, suggests that the structural coloration in [(PDADMA/Ti₃C₂T_{z})₂/(PDADMA/PSS)ₘ]ₓ heterostructures is similar to a distributed Bragg reflector or quarter-wave optical stack. In one aspect, block A (PDADMA/Ti₃C₂T_{z}) can be a high refractive index material while block B (PDADMA/PSS) can be a low refractive index material (see FIGS. 7A-7B).

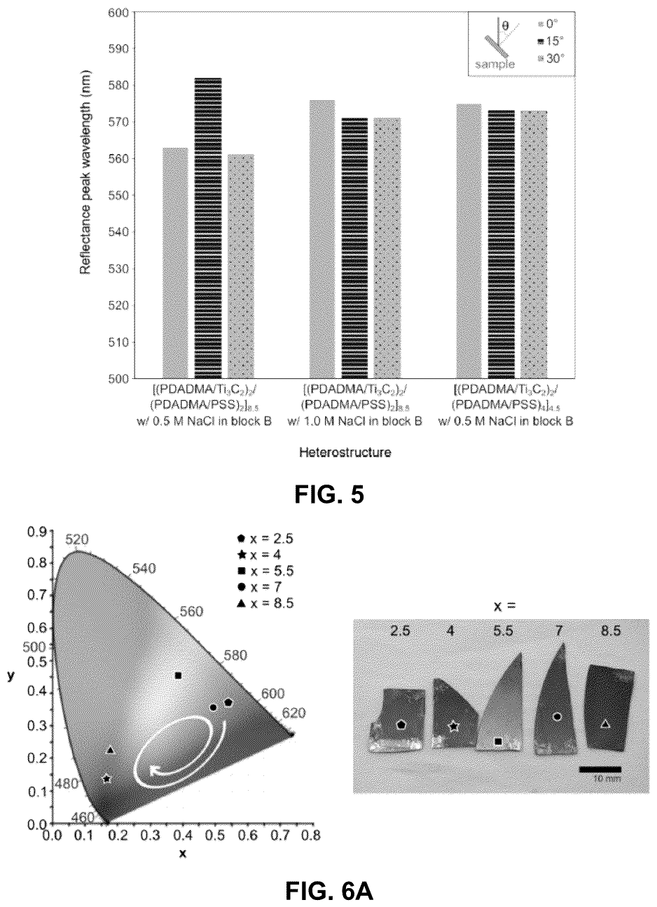

If the observed color changes with viewing angle, then structural col-oration is considered angle-dependent (such as with the iridescence of a soap bubble or the feathers of a pigeon). If the observed color remains the same with changes in the viewing angle, then the structural coloration is considered angle-independent. Because the reflected color is related to the peak reflectance wavelength of an object's reflectance spectrum, angle-dependent optical characterization can be used to determine whether the structural color is angle agnostic. In the case of angle-independent structural coloration, the peak in reflectance should occur at the same wavelength at different incident light angles. Conversely, if the reflectance peak shifts for different incident angles of light, then structural coloration is angle-dependent, and the object exhibits iridescence. By visual inspection, all the heterostructures exhibited structural color independent of angle except for [(PDADMA/Ti₃C₂T_{z})₂/(PDADMA/PSS)₂]_{8.5} with 0.5 M NaCl in block B. To compare, UV-vis reflectance spectra were collected at multiple incident angles of light for each hetero-structure. The selected angles were 0°, 15°, and 30° (based on machine limitations) and were defined as the angle between the sample normal and beam of incident light. Two of the three samples represented in FIG. 5, [(PDADMA/Ti₃C₂T_{z})₂/(PDADMA/PSS)₂]_{8.5} with 1.0 M NaCl in block B (FIG. 5 center), and [(PDADMA/Ti₃C₂T_{z})₂/(PDADMA/PSS)₄]_{4.5} with 0.5 M NaCl in block B (FIG. 5 right), were selected as representatives for their heterostructure set. [(PDADMA/Ti₃C₂T_{z})₂/(PDADMA/PSS)₂]_{8.5} with 0.5 M NaCl in block B (FIG. 5 left), which exhibited angle-dependent structural coloration, was selected to represent its heterostructure set.

Examination of FIG. 5 confirms the visual observations described herein. The reflectance peak wavelengths of the [(PDADMA/Ti₃C₂T_{z})₂/(PDADMA/PSS)₄]ₓ with 0.5 M NaCl in block B heterostructure and the [(PDADMA/Ti₃C₂T_{z})₂/(PDADMA/PSS)₂]ₓ with 1.0 M NaCl in block B heterostructure remain nearly the same despite the incident angle of light (around 571 nm where x=8.5 and 573 nm where x=4.5, respectively), consistent with angle-independent structural coloration. In contrast, the heterostructure of [(PDADMA/Ti₃C₂T_{z})₂/(PDADMA/PSS)₂]_{8.5} with 0.5 M NaCl in block B exhibited a reflectance peak wavelength that changed with the different incident light angles. Specifically, at 0°, 15°, and 30°, the reflectance peaks occurred at 563 nm, 582 nm, and 561 nm, respectively; this observation is consistent with angle-dependent structural coloration. As determined by the previously discussed QCM data, this specific heterostructure composition contains the highest amount of PDADMA/PSS.

Within the literature, PDADMA/PSS LbL films were determined to show angle-dependent structural coloration. Also in literature, and previously mentioned, Ti₃C₂T_{z} has been used under films comprised of SiO₂ that show angle-dependent structural coloration to make them angle-independent structurally colored. It is speculated that the [(PDADMA/Ti₃C₂T_{z})₂/(PDADMA/PSS)₂]_{8.5} with 0.5 M NaCl in block B heterostructure does not contain enough MXene in the structure to offset the angle-dependent structural coloration nature of the PDADMA/PSS block, causing this to be the only composition to show angle-dependency instead of angle-independency in the structural coloration. Another explanation for the differing structural color angle dependency could be due to some form of interlayer roughness between the two blocks in the heterostructures. Texture can influence optical response. Revisiting the AFM images of the heterostructures (FIG. 1C), nano-wrinkles were observed in the surface, caused by overlapping MXene nanosheets. The images (specifically FIG. 1C right) also show how the wrinkles are preserved after the deposition of block B, displaying how the interlayer roughness is carried throughout the hetero-structure. These wrinkles may cause a diffuse reflection where light is scattered in multiple directions, which could induce consistent structural color independent of viewing angle. Because the [(PDADMA/Ti₃C₂T_{z})₂/(PDADMA/PSS)₂]ₓ with 1.0 M NaCl in block B and [(PDADMA/Ti₃C₂T_{z})₂/(PDADMA/PSS)₄]ₓ with 0.5 M NaCl in block B heterostructure systems contain more MXene nanosheets and these nanosheets are the cause of the wrinkles on the interlayer surfaces, this could also explain why all block pairs within these heterostructure systems exhibit angle-independent structural color.

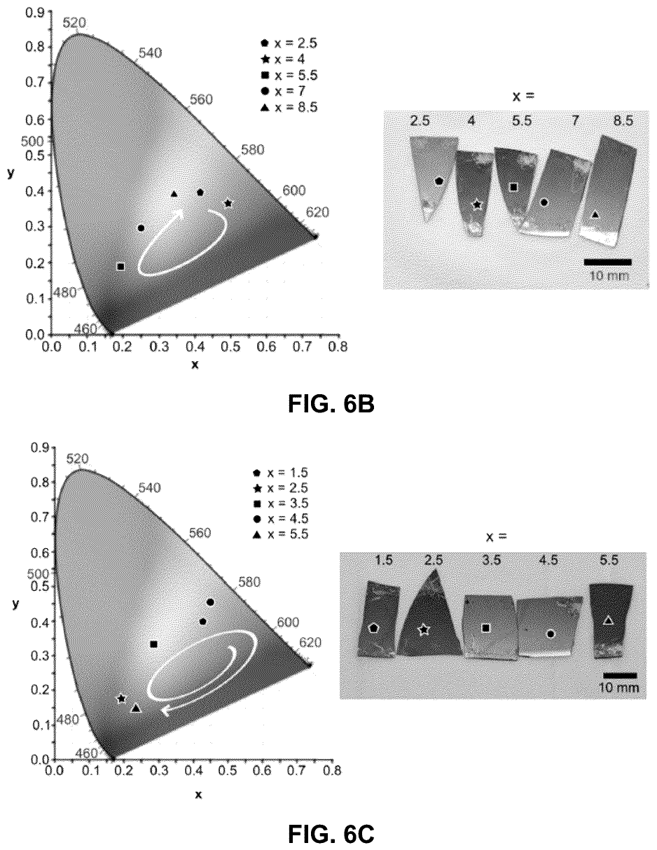

To further validate the observed structural coloration (both angle-independent and angle-dependent), the CIE 1931 chromaticity coordinates (x, y, Y) were calculated and plotted. In FIGS. 6A-6C, a photo of each film set on an Si substrate is displayed with the corresponding CIE color space plot. Within this plot the luminosity (the Y coordinate) value is not represented; however, the values are summarized in Table 2. Heterostructures made with 0.5 M NaC in 2 LP block B (FIG. 6A) are observed to go from a deep orange (x=2.5) to blue (x=4), to yellow (x=5.5), to another hue of orange (x=7), and then back to another hue of blue (x=8.5), as x grows. Heterostructures made with 1.0 M NaCl in 2 LP block B (FIG. 6B) go from gold (x=2.5) to orange (x=4), to blue (x=5.5), to turquoise (x=7), and to green (x=8.5). The 0.5 M NaC in 4 LP block B containing heterostructures (FIG. 6C) first appear brown at x=1.5, then become blue (x=2.5), pale teal-green (x=3.5), yellow (x=4.5), and then deep purple (x=5.5).

TABLE 2
1931 CIE Color Space Coordinates of Heterostructures
at Different Values of x¹

| | | | |
|---|---|---|---|
| x | 1931 CIE x | 1931 CIE y | 1931 CIE Y |

[(PDADMA/Ti₃C₂T_{z})₂/(PDADMA/PSS)₂]ₓ with 0.5M NaCl in block B

| | | | |
|---|---|---|---|
| 2.5 | 0.537 | 0.373 | 11038 |
| 4 | 0.165 | 0.143 | 18981 |
| 5.5 | 0.374 | 0.455 | 98254 |
| 7 | 0.490 | 0.362 | 38035 |
| 8.5 | 0.174 | 0.224 | 20181 |

[(PDADMA/Ti₃C₂T_{z})₂/(PDADMA/PSS)₂]ₓ with 1.0M NaCl in block B

| | | | |
|---|---|---|---|
| 2.5 | 0.411 | 0.399 | 78672 |
| 4 | 0.489 | 0.368 | 26504 |
| 5.5 | 0.190 | 0.193 | 23710 |
| 7 | 0.245 | 0.301 | 55542 |
| 8.5 | 0.341 | 0.392 | 56347 |

[(PDADMA/Ti₃C₂T_{z})₂/(PDADMA/PSS)₄]ₓ with 0.5M NaCl in block B

| | | | |
|---|---|---|---|
| 2.5 | 0.428 | 0.398 | 28777 |
| 4 | 0.191 | 0.179 | 35880 |
| 5.5 | 0.288 | 0.338 | 91433 |
| 7 | 0.450 | 0.456 | 134541 |
| 8.5 | 0.236 | 0.147 | 15147 |

¹Different values of x represent different numbers of LbL cycles.

The 1.0 M NaCl in 2 LP block B-containing heterostructures noticeably follow a pattern that follows the Newton series of colors. This series characteristically describes a cycling sequence of ordered color groups that is often seen in nature and within thin films. In this case, as x increases, colors move clockwise around the CIE color space (starting with the gold color of x=2.5; as displayed by the white spiral in FIG. 6B). This phenomenon may also be evident within the 0.5 M NaCl in 2 LP block B containing hetero-structures with the pattern going twice clockwise around the CIE color space (reference the white spiral in FIG. 6A); however, due to the large jumps across the color space with the selected LP intervals, further investigation is needed to confirm. Similarly, heterostructures with 0.5 M NaCl in 4 LP block B also follow the same twice-around clockwise pattern (see white spiral in FIG. 6A).

The optical properties of a material define how light contorts, or refracts, when passing through a medium or material. The complex refractive index, 5, is expressed by a real part, n, and an imaginary part, ik, to obtain:

$$\tilde{n} = n + ik \qquad ( 2 )$$

In the case of the polyelectrolyte blocks of the heterostructures, the wavelength dependency of refractive index can be modeled using the Cauchy dispersion model:

$$n ( λ ) = A + \frac{B}{{λ}^{2}} + \frac{C}{{λ}^{4}} \qquad ( 3 )$$

The Cauchy model assumes there is negligible influence of the extinction coefficient, k. With this assumption, only the real part, n, of the complex refractive index remains and the Cauchy model is the most abecedarian formula that relates refractive index to wavelength with the help of the parameter constants, A, B, and C, that are determined based on equation fitting around known values of n and A.

However, unlike the polyelectrolytes in block B and dielectric nano-materials in previously reported optical filters, the Cauchy dispersion model cannot be used to describe the optical properties of the Ti₃C₂T_{z} MXene/PDADMA blocks. When derived via spectroscopic ellipsometry analysis, FIG. 7A, there is a significant contribution from the extinction coefficient throughout visible and infrared wavelengths. There is also variation within the real part of the refractive index as well due to Kramers-Kronig relations. As such, these layer materials must be modeled with a Drude-Lorentz model:

$$\tilde{n} ( ω ) = n ( ω ) = ικ ( ω ) = \sqrt{{ε}_{1} ( ω ) + ι {ε}_{2} ( ω )} \qquad ( 4 )$$

$${ε}_{1} = {ε}_{∞} ( 1 - \frac{{ω}_{p}^{2}}{{ω}^{2} + {γ}^{2}} ) \qquad ( 5 )$$

$${ε}_{2} = \frac{{ω}_{p}^{2} {γε}_{∞}}{{ω}^{3} + {ωγ}^{2}} \qquad ( 6 )$$

Where ε₁ is the real component and ε₂ is the imaginary component of a materials' dielectric constant. These components are defined by the permittivity of free space (ε_{∞}), frequency of light (ω), plasma frequency (ωₚ), and damping constant (γ).

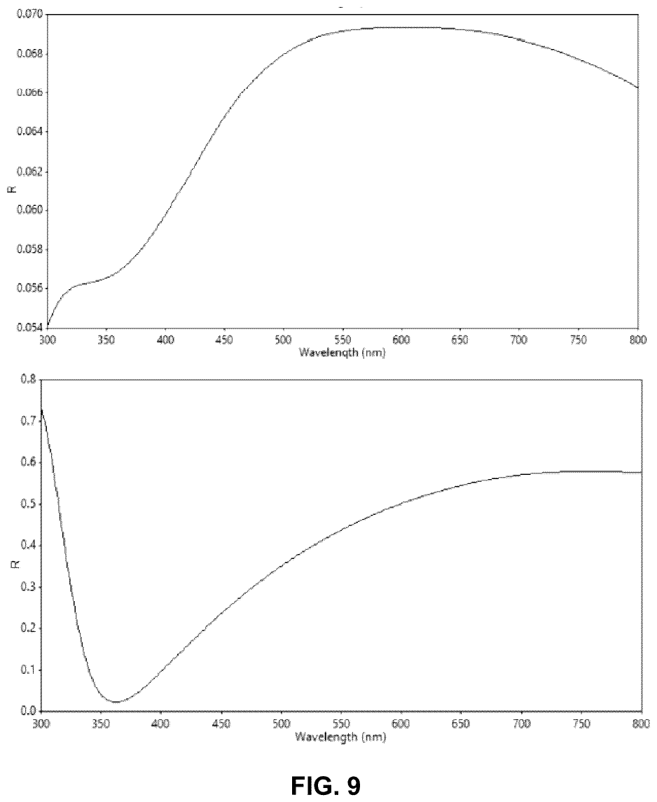

The n and k of the two blocks were entered into OpenFilters software and used to generate a modeled reflectance spectrum for a selected number of block pairs. QCM data was used to choose initial thickness inputs for the blocks. The first modeled spectrum (see FIG. 9) under-estimated the reflectance spectrum for a [(PDADMA/Ti₃C₂T_{z})₂/(PDADMA/PSS)₄]_{2.5} heterostructure with 0.5 M NaCl in block B. Despite being off by a factor of 10, the general shape of the generated spectrum matched the experimental reflectance spectrum for this heterostructure (found in FIG. 4C).

Because n and k of the PDADMA/MXene block were calculated from a sample only containing block A, the loss of loosely adhered MXene sheets through LbL stripping that occurs in the heterostructure is not optically accounted for. So, the n and k of block A were multiplied by a constant with a value between 0 and 1 to adjust the model-generated reflectance spectrum. Various values were fitted and a multiplier value of 0.19 produced a reflectance spectrum most similar to the experimentally measured reflectance. It should be noted that a constant multiplier was also applied to n and k of block B, but then removed as it did not contribute to matching the experimental data. This is likely due to the use of a Cauchy model (i.e., normal dispersion only) to block B (seen in FIG. 7B), as discussed in the previous section, compared to the Drude-Lorentz model for block A representing anomalous dispersion characteristics. An improved derivation of block A optical properties is likely possible upon appending variable angle spectroscopic ellipsometry data with transmission intensity data and will be the focus of future work.

The OpenFilters software is equipped with a feature that allows the user to input optical targets and then consequently adjust the block thicknesses to achieve or approximate the targets. Through using this feature with reflectance targets that matched experimental reflectance data at wave-lengths of 800 nm, 500 nm, and 390 nm, and manual manipulation of the thickness input, the model reflectance spectrum in FIG. 7C (magenta line) was created. The model block thicknesses are 20 nm for block A and 31 nm for block B.

In FIG. 7C, both the experimental and the modeled spectra for the [(PDADMA/Ti₃C₂T_{z})₂/(PDADMA/PSS)₄]_{2.5} heterostructure with 0.5 M NaCl in block B are plotted showing the visible wavelength regime, about 300 nm to 800 nm. Despite artificially adjusting the parameters to generate the modeled spectrum, it remains slightly off from the experimental. From 300 to 315 nm, the model underestimates the reflectance. From 315 nm to 770 nm the model then overestimates the reflectance, however at 500 nm the two values differ by less than 1%. While the [(PDADMA/Ti₃C₂T_{z})₂/(PDADMA/PSS)₄]_{2.5} model does not show the local reflectance minimum at 331 nm, when additional blocks were added to the model to represent the [(PDADMA/Ti₃C₂T_{z})₂/(PDADMA/PSS)₄]_{3.5} heterostructure with 0.5 M NaCl in block B (see FIG. 9), the experimental reflectance minimum is reflected in the model. However, this generated spectrum is shifted to the right (red shift) when compared to the experimental data (FIG. 4C).

In this study, three different LbL heterostructures including two main alternating blocks were produced. The first block, MXene-rich A, contained 2 LPs of PDADMA/Ti₃C₂T_{z}, while the second block, polymer-rich B, contained either: 2 LPs of PDADMA/PSS assembled with 0.5 M NaCl, 2 LPs of PDADMA/PSS assembled with 1.0 M NaCl, or 4 LPs of PDADMA/PSS assembled with 0.5 M NaCl. By examining the growth behavior of each heterostructure, that the thicknesses of the blocks and the MXene content were demonstrated to be controllable at the nanometer scale. The color of each heterostructure, as represented by the reflectance spectra, changed with heterostructure type and thickness. The majority of the heterostructures exhibited angle-independent structural coloration, while only one showed angle-dependent structural coloration, possibly due to internal roughness between the blocks.

These results allow for a glimpse into deeper understanding of how varying the spatial placement and concentration of MXene nanosheets within a LbL heterostructure in terms of growth and optical properties.

### Methods

Materials: Poly(diallylmethylammonium) chloride (MW=200,000 to 350,000 g/mol, 20 wt % in water) and sodium chloride (NaCl) were purchased from Sigma-Aldrich. Polystyrene sulfonate sodium (MW=500,000 g/mol) and linear polyethyleneimine (LPEI, MW=25,000 g/mol) were acquired from Poly-sciences Inc. Citric acid (CA, MW=192.13 g/mol), isopropyl alcohol (IPA, 99%), acetone (>99.55%), and slide glass (75×25×1 mm) were obtained from VWR. Ti/Au quartz crystal substrates (5 MHz) were attained from Inficon. Si wafers were purchased from University Wafer. 18.2 MQ cm (Milli-Q) water was accumulated from a Milli-Q integral water purification system for ultrapure water.

MAX phase synthesis: Nanolayered, hexagonal transition-metal carbides/nitrides, or MAX phases, are the precursors of MXenes. These materials follow the formula Mn+1AXn, where n=1-3, M is a transition metal, A is an A-group element, and X is carbon or nitrogen. MAX phase powders were fabricated by pressureless sintering, as in previous reports. Ti, Al, and TiC powders were combined using a molar ratio of Ti:AI:C=3:1.2:1.95 to create the Ti₃AlC₂ MAX phase. The powders were mixed in a jar rolling mill (300 rpm, 12 h) with 35 mm diameter ZrO₂. Ensuing milling, powders were sintered in alumina crucibles in a 50 mm alumina tube furnace at a rate of 10° C./min to 1510° C. under constant argon flow (4 h). Powders were cooled to room temperature, then ground into particles 20-45 μm in size by mortar and pestle.

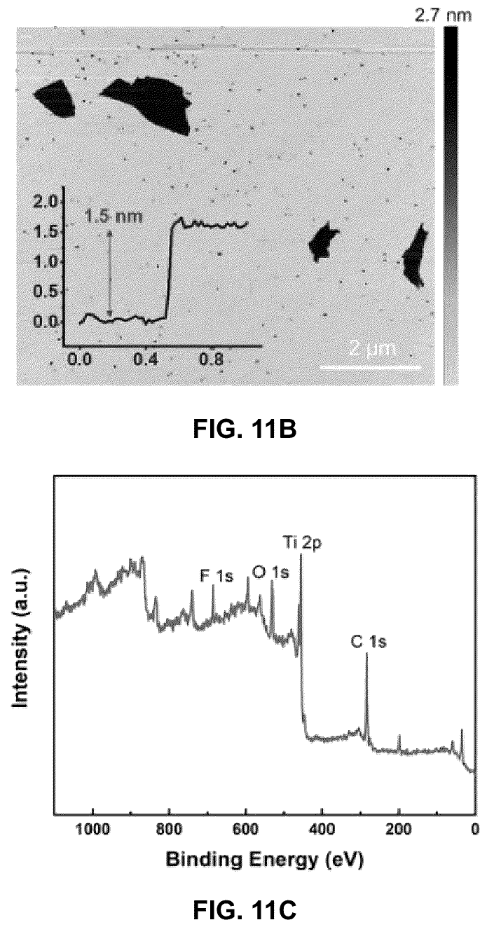

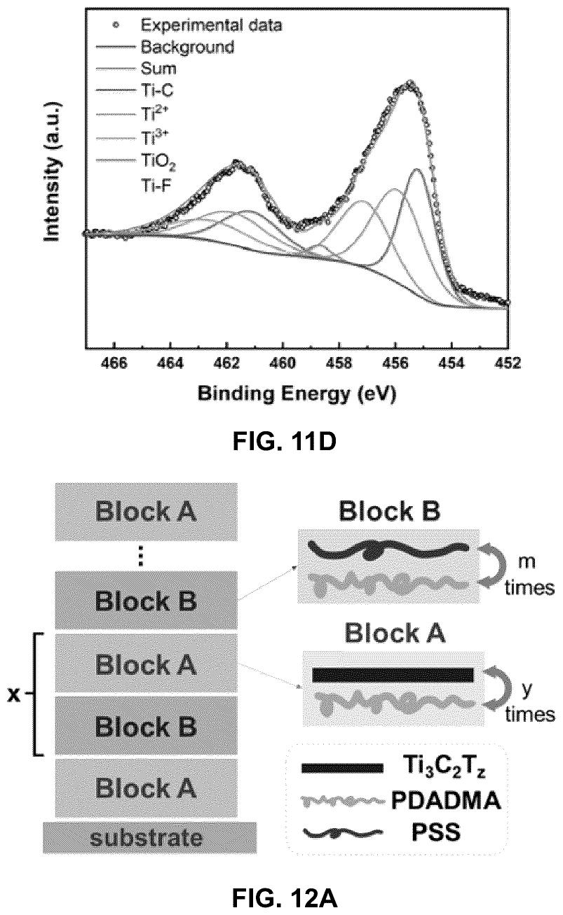

MXene synthesis: MAX phase powders were processed into MXene colloidal dispersions using the procedures described in previous reports. In brief, to form HF in situ for etching, 3.3 g LiF was added to 50 mL of 6 M HCl (constantly stirred) in a polypropylene beaker. Before use, holes were drilled into the top of the beaker to prevent pressure build-up and help regulate heat from the exothermic reaction. Following dissolution, the solution was heated to 40° C. 5 g of Ti₃AlC₂ at a rate of 1 g/min then set to etch (45 h). The mixture was brought to pH 6, by removing excess etchant in a centrifugal washing progress (9000 rpm, 20 min). Dimethylsulfoxide (16.67 mL per gram of starting MAX phase) was added to the Ti₃C₂T_{z} clay, then stirred (20 h). A centrifugal solvent exchange method with deionized water (5000 rpm, 4 h) for three cycles was employed to rid the clay of excess intercalants. Bath sonication (1 h) was used to delaminate the clay. The resulting dispersion was centrifuged (3500 rpm, 1 h) and the supernatant was collected. The concentration of the final mono- and few-layer Ti₃C₂T_{z} nanosheet dispersion was deduced by vacuum filtration of a known dispersion volume. MXene characterization of this synthesis method is reported in FIGS. 11A-11D.

Layer-by-layer assembly: Once the MXene dispersion was synthesized, the concentration was diluted to 1 mg/mL. The MXene solution acted as the anion within the first distinct LbL block (block A) of the heterostructure; the polycation was PDADMA. To improve oxidative stability throughout the LbL assembly process, 1 mg/mL of CA was added as an antioxidant to all block A ion solutions and washes. The second cation/anion combination within the heterostructure (block B), again used PDADMA as a polycation, while the anion in this block was PSS. Polyelectrolyte solutions and Milli-Q washes within block B contained NaCl (0.5 M or 1.0 M).

Glass and Si wafer substrates were bath sonicated in isopropyl alcohol for 15 min, then washed with water and acetone. Once dried, the substrates were plasma treated for 5 min. Plasma treatment allows for the substrate to become negatively charged and hydrophilic. Ti/Au quartz crystal substrates followed a slightly different preparation protocol. First, they were plasma treated for 10 min, then cleaned using a basic piranha solution (5:1:1 Milli-Q water: ammonium hydroxide: hydrogen peroxide, at 75° C.). Afterwards, quartz crystals were plasma treated for 10 min.

Subsequently, substrates were immersed in LPEI solution (1 mg/mL, pH 4, 15 min) to create a base layer. The substrate was then consecutively submerged in three washes of Milli-Q water and 1 mg/mL CA (1 min each). After the washing, the substrate was dried with compressed air to prevent contamination and aggregation. Following this, samples were placed into the MXene dispersion (15 min), washed (Milli-Q water and CA, 1 min) thrice, and dried. This created a single-layer pair (LP). To continue assembling block A of the heterostructure, the substrates were placed into PDADMA solution as before, washed, dried, then submerged once again in the MXene dispersion. This alternating was continued until the desired number of LPs was reached within block A.

Block B was created on top of block A by following the same assembly procedures for PSS and block B PDADMA, apart from the washes containing a selected concentration (0.5 M or 1.0 M) of NaCl, instead of CA. Once the necessary number of LPs in block B were created, additional block A LPs were assembled, once again repeating the same procedures until the heterostructure was completed. Samples were stored at room temperature under vacuum to remove any water in between layers and protect from MXene oxidation.

Thin film characterization: To characterize the growth profiles of the films, spectrophotometry and profilometry were used. The film thickness in relation to layer pair number was measured using a profilometer (KLA Tencor D-500). The profilometer was also used to determine the root-mean-square (RMS) roughness (Rq). Quartz crystal microbalance (QCM; Inficon MAXTEK) was used to con-firm film growth by recording the frequency change for every LP then using the Sauerbrey equation to obtain the mass deposited. Surveying the films assembled on the glass slides with a UV-Vis-NIR spectrophotometer (Shimadzu SolidSpec-3700 UV-vis-NIR, Hitachi U-4100 UV-Vis-NIR), absorbance and reflectance were measured. Along with confirming growth, measuring absorbance also allowed for a glimpse into the optical response of the heterostructures. The reflectance spectra also quantified optical performance.

Film sets were mapped within the CIE 1931 color space. To create the chromaticity plot, a representative pixel within digital images of the films was selected and translated into CIE (x, y, Y) coordinates, then plotted in the color space.

Spectroscopic ellipsometry (Nanofilm EP3 ellipsometer) was utilized to collect optical dispersion data to derive the optical constants of the two blocks (A and B) on single-side polished Si wafers. The Si wafers had a native oxide of ˜2 nm in thickness. Analysis using CompleteEASE v6.55 (J. A. Woollam) was performed to gather refractive indices and extinction coefficients from the optical dispersion data. OpenFilters software was used to create a multilayer one-dimensional model of the heterostructures using the derived optical constants.

Scanning electron microscopy (SEM; JEOL JSM-7500F) was also used to examine the morphologies of the different heterostructures. Si substrates of the completed films were scored and placed into liquid nitrogen for 1 min, then removed and fractured along the score line. This process allows for a clean break for the best view of the heterostructure's cross section. Before mounting the sample, it was sputter coated until a thickness of 5 nm was achieved to reduce film charging.

Transmission electron microscopy (TEM; Thermo Fisher Titan The-mis Z 300) was used to view the cross-sectional morphology of the heterostructure. TEM samples were prepared using a Tescan LYRA-3 Model GMH dual-beam focused ion beam (FIB) system. The ion (Ga⁺) beam operated at 30 kV with a beam current ranging from 12 nA down to 70 pA. The TEM lamella preparation consists of 4 steps: 1. Pt deposition of a protection layer on the area of interest; 2. Milling symmetrical trenches around the lamella and U cut; 3. Lift out using the nanomanipulator and attached to TEM grid; 4. Final thinning and cleaning. TEM observation was conducted in an aberration-corrected transmission electron microscope at 300 kV. The composition of the sample was analyzed using a Super-X EDS in the STEM mode. The camera length in the STEM mode was 115 mm.

An atomic force microscope (AFM; Bruker Dimension Icon AFM) inspected the surface morphologies of the heterostructures. Both block A and B were examined as the terminating block, leaving the MXene layer on top in block A and the PSS layer on top in block B. Each film was created on a Si substrate.

### Example 2: Applications of the Heterostructures

### Humidity Sensing

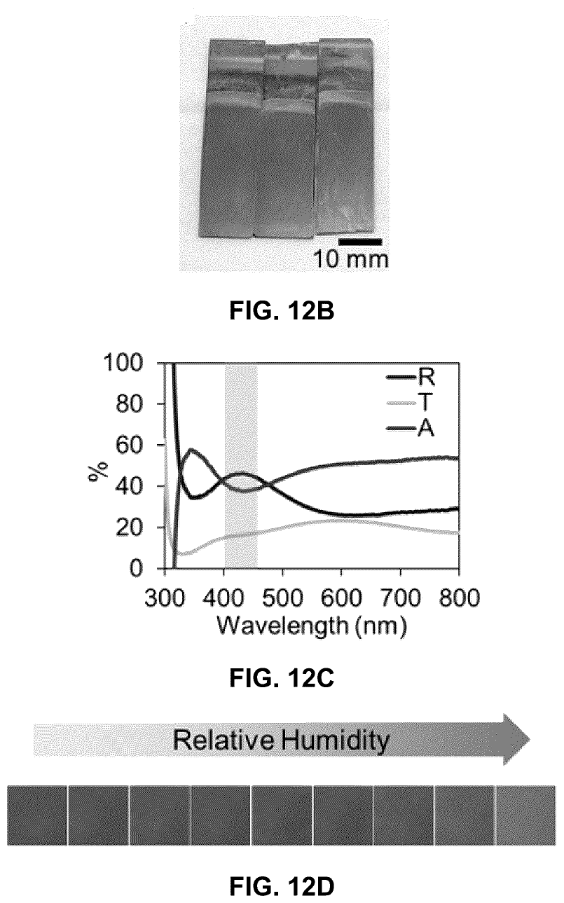

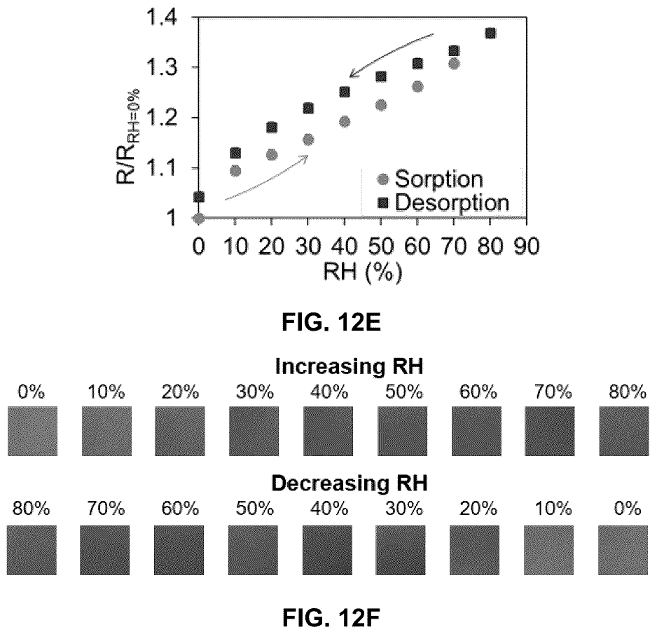

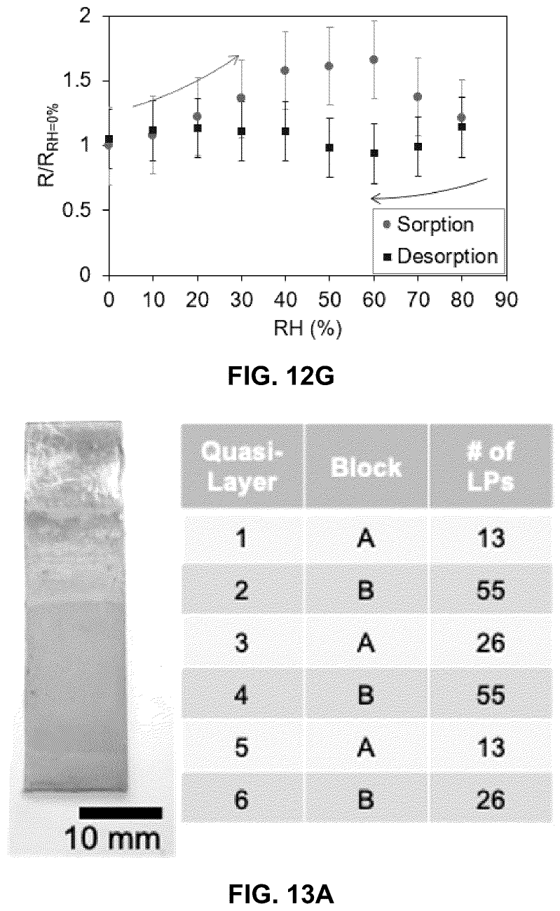

The heterostructures change color with relative humidity (RH). With high RH values, water intercalates into the heterostructures, changing the thickness of both the blocks. This thickness change will affect the film's color (FIG. 12D) and resistance (FIG. 12E). Color changes are largely reversible, though a hysteresis is observed as seen in FIG. 12E. As relative humidity increases, resistance increases, and as relative humidity decreases, resistance decreases. Different heterostructures result in different color changes and different resistance profiles as seen in FIGS. 12F-12G. As relative humidity increases to 80% from 0%, a yellowish heterostructure adopts an indigo color, which is reversible. Two regions are noted in the resistance measurements for sorption, with a positive correlation region from 0% to 60% (increase in RH equates to increase in resistance) and a negative correlation region from 60% to 80% (increase in RH equates to decrease in resistance). For desorption, three regions are noted. From 80% to 60% RH, resistance decreases with RH. From 60% to 30% RH, resistance increases as RH decreases. From 30% to 0%, resistance remains constant.

### Non-Spectral Colors

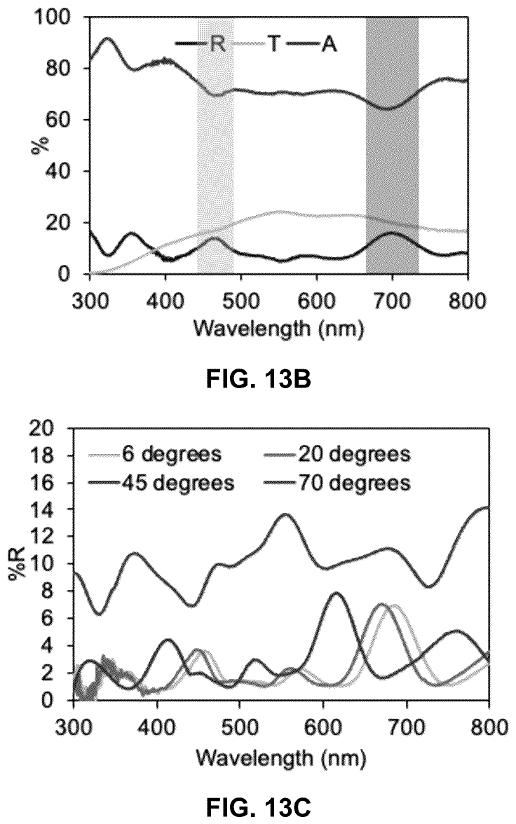

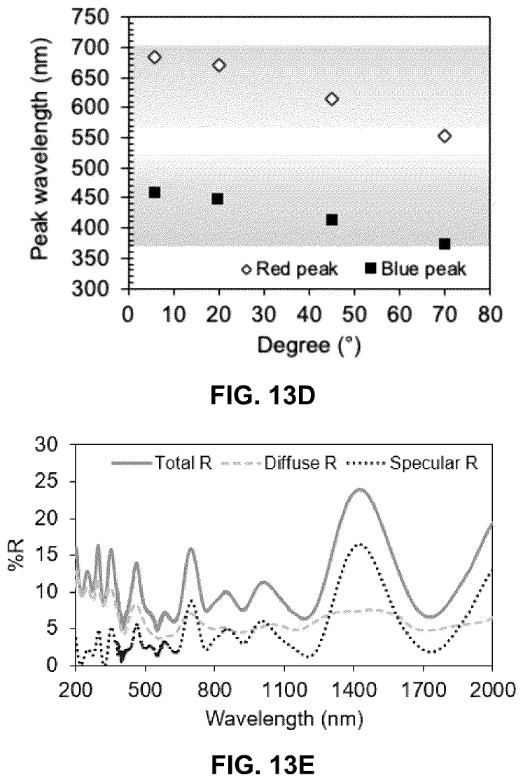

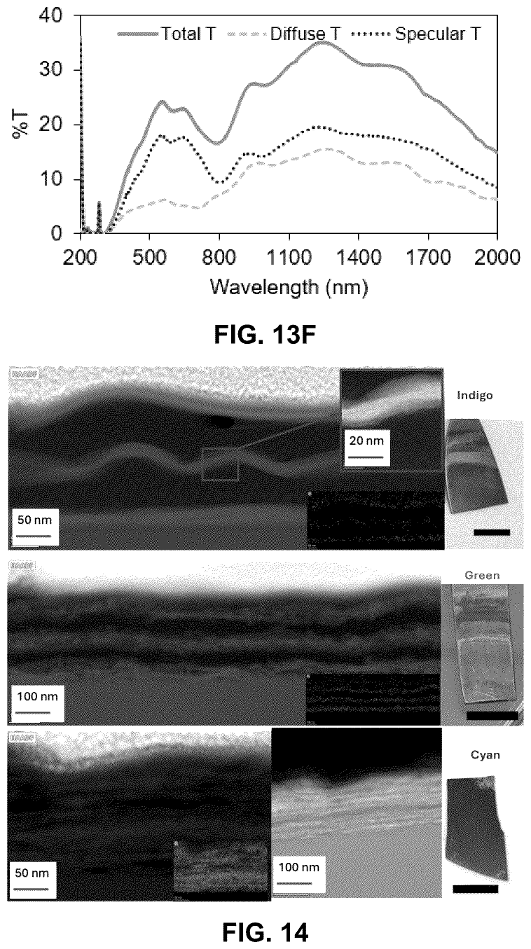

Non-spectral color results from the combination of two or more spectral colors, with examples including magenta, pink, and cyan. LbL heterostructures with non-spectral structural coloration were created using heterostructures that produce pink/magenta structural color from red and blue/violet reflectance peaks (FIGS. 13A-13E). Interestingly, it was observed that the color produced by this structure was angle-dependent. It is hypothesized that angle dependent structural color is correlated to the internal roughness of the MXene block, in which lower roughness blocks would yield a greater degree of angle dependence. Angle-dependency is responsible for iridescence appearances in nature, but for certain applications a constant color (without iridescence) is desired. FIG. 14 shows cross-sectional transmission electron microscope images (TEMs) of heterostructured coatings that produce indigo, green, and blue structural colors just by changing the relative thicknesses and layerings of the two types of blocks. Green and cyan are non-spectral colors.

### Polarized Optical Coatings

LbL films have demonstrated not only structural color but also chiral/optical polarization. Kim et al. created chiral gold nanoparticle and polyurethane LbL composites on a twisted poly(dimethyl siloxane) (PDMS) substrate, followed by release of the twist after assembly, resulting in induced mechanical stresses and optical polarization. The gold nanoparticles had no chiroptical activity on their own, but their LbL assembly on the twisted PDMS led to polarization rotation due to the creation of nanoparticle ‘S’ shaped chains from the non-planar geometry of the original substrate. Using a chiral assembly agent can also induce polarization. Specifically, Lang et al. used CdS nanoparticles, D- and L-cysteine, and polyelectrolytes to create LbL nanostructured semiconductor films with strong rotatory optical activity. The MXene heterostructures produced here can similarly control the polarization of light.

For inducing polarization, select heterostructures were induced on twisted PDMS substrates, following the method of Kim et al. Polarization reflectance of the heterostructure was measured at multiple angles.

### Example 3: Tunability of the Heterostructures

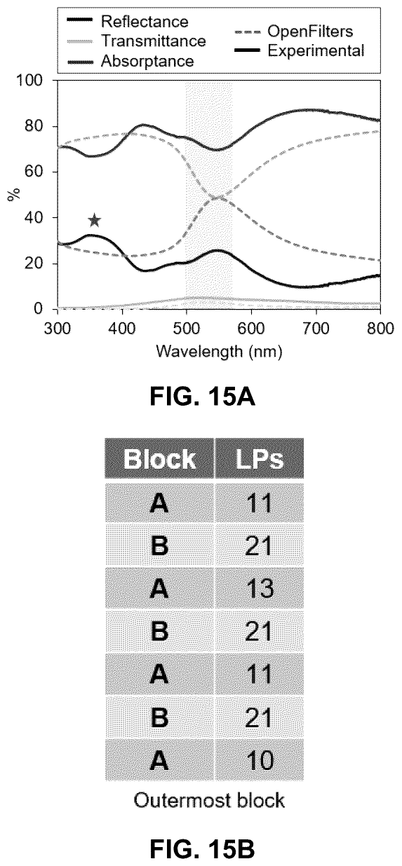

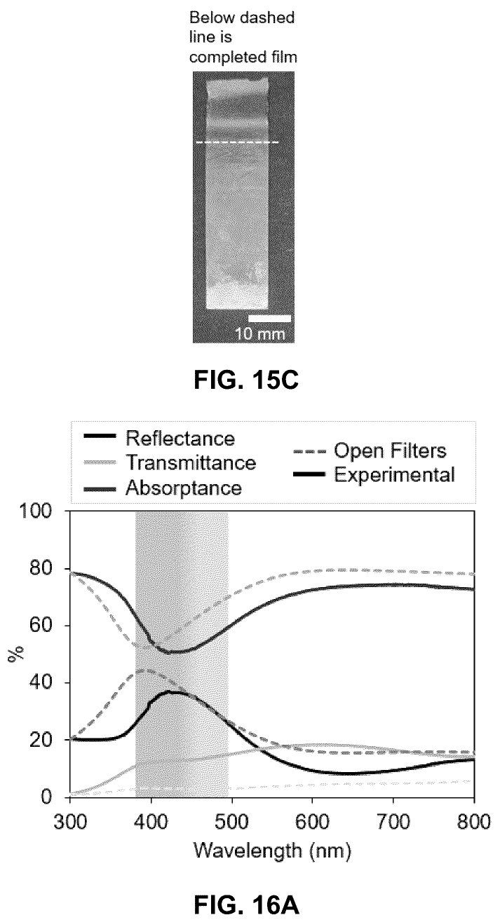

The disclosed heterostructures are tunable. For example, to create a green heterostructure an appropriate reflectance peak is chosen, in this case, having a wavelength of 550 nm. The optical target based on OpenFilters prediction was 50% reflectance at 550 nm and the resulting heterostructure was green and had a formula [(PDADMA/Ti₃C₂T_{z})_{y}/(PDADMA/PSS)₁₁]_{3.5}. In an initial experiment, the R peak in the experimental structure had the correct wavelength but a lower intensity with an additional peak in the violet range, explaining why the green produced had a slight teal tint. See FIGS. 15A-15C.

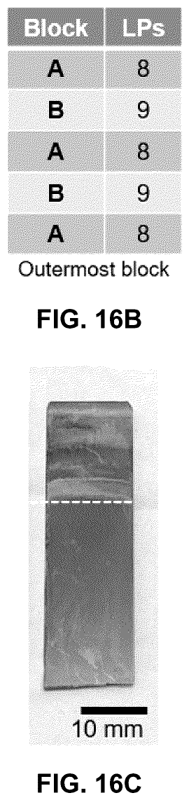

For an indigo heterostructure having a formula [(PDADMA/Ti₃C₂T_{z})₃/(PDADMA/PSS)₉]_{2.5}, the optical target was 45% reflectance at 400 nm. The experimental R peak red shifted to be in both the violet and the blue range (see FIGS. 16A-16C).

### Angle Dependency of Structural Color

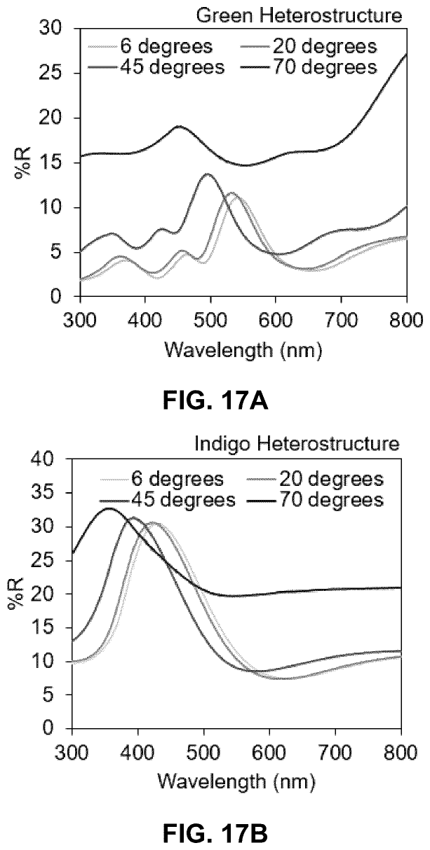

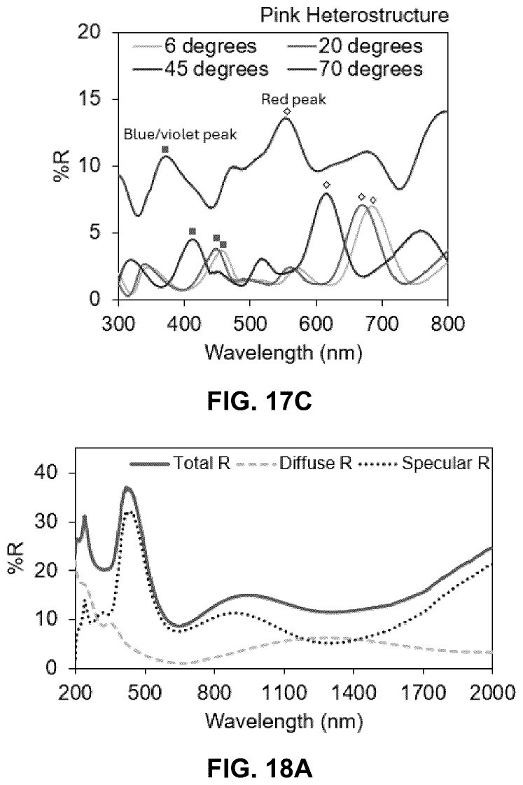

The reflectance spectrum at various angles of incident light indicates the angle dependency of the structural colors achieved. If there is little to no shift in the reflectance peaks, the color is angle-dependent. For moderate to large shifts, the color is angle-dependent. All of the heterostructures produced thus far show some degree of blue shift and thus some degree of angle dependency. Green (FIGS. 15A-15C) and indigo (FIGS. 16A-16C) remain in their respective color ranges until 70° and exhibit no visible color change. A greater shift is observed in the pink/magenta heterostructure (FIGS. 13A-13F) with the peaks being out of their respective color ranges by 45° and a visible color change (see also FIGS. 17A-17C).

### Specular Versus Diffuse Reflectance and Transmittance

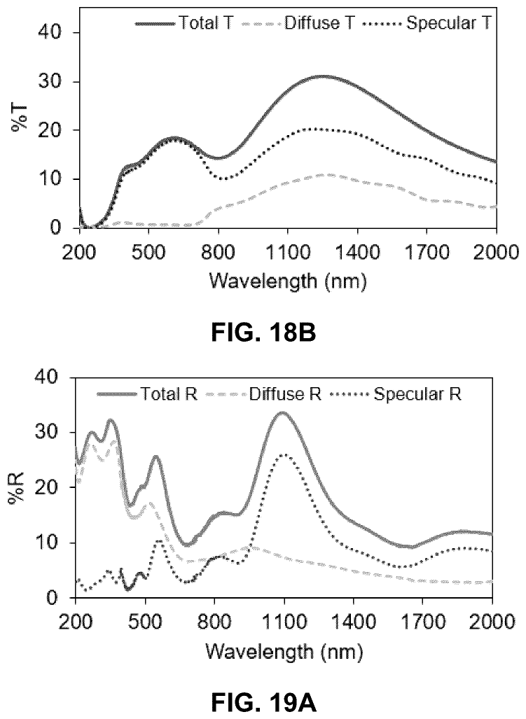

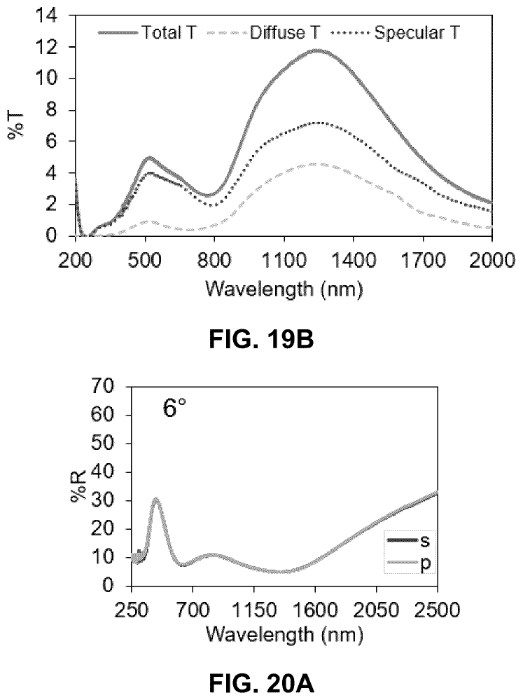

Transmitted and reflected light can be split into two types. Under diffuse conditions, light is transmitted and/or reflected in a broad range of directions, leading to a matte appearance caused by a rough surface or subsurface scattering. Under specular conditions, light is transmitted and/or reflected in a singular definite direction, leading to a glossy or mirror-like appearance caused by a smooth surface or a lack of subsurface scattering. Specular versus diffuse reflectance and transmittance can be seen in FIGS. 13E-13F for the pink/magenta heterostructure, in FIGS. 18A-18B for the indigo heterostructure, and FIGS. 19A-19B for the green heterostructure.

### S-Plane and P-Plane Polarized Variable Angle Reflectance

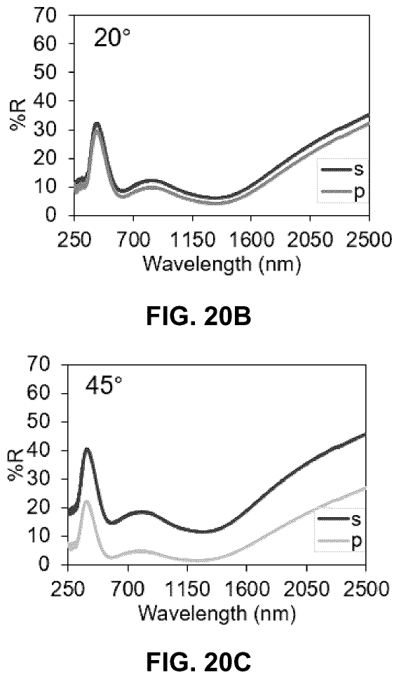

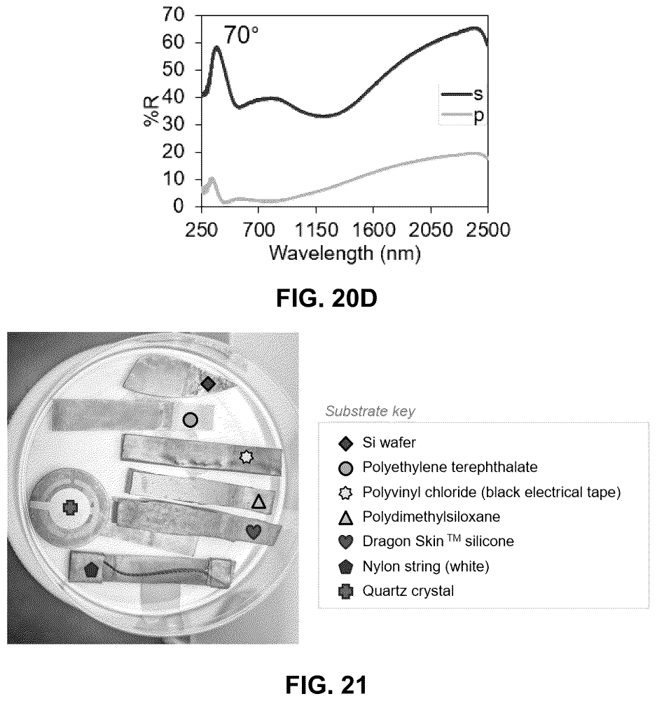

Linearly polarized light is reflected in two planes, the s-plane (perpendicular to the incident light plane) and the p-plane (parallel to the incident light plane). FIGS. 20A-20D show trends for the indigo heterostructure, but similar trends were observed for the pink/magenta and green heterostructures, as well. In general, as the angle of incident light increases, the s-spectrum increases and the p-spectrum decreases, which is common in multilayered films and has applications in anti-counterfeiting. As the angle increases, a mismatch is observed in peak shape and position between the s and p spectra, a plasmon response due to MXene sheet alignment.

### Substrate Versatility

FIG. 21 shows the [(PDADMA/Ti₃C₂T_{z})₃/(PDADMA/PSS)₉]_{2.5} LbL heterostructure coated on a variety of different substrates including an Si wafer, polyethylene terephthalate, polyvinyl chloride, polydimethylsiloxane, Dragon Skin™ silicone, white nylon string, and quartz crystal. Although heterostructures appear different on several of the substrates, deposition is possible, and base anchor layers can be added to ensure that the full heterostructure adheres to complex substrates.

### Example 4: Further Investigations of Humidity Response of the Heterostructures

It has previously been shown that, in PDADMA/Ti₃C₂T_{z} multilayers, water molecules intercalate between the layers, resulting in an increase in thickness, an increase in MXene layer distances, and an increase in resistance. In the present case, a change in block thicknesses results in a change in film color. Thus, a multi-factor response can be seen with the present films under different humidity conditions, including a colorimetric response in addition to electrical resistance of the films and/or mass of the films.

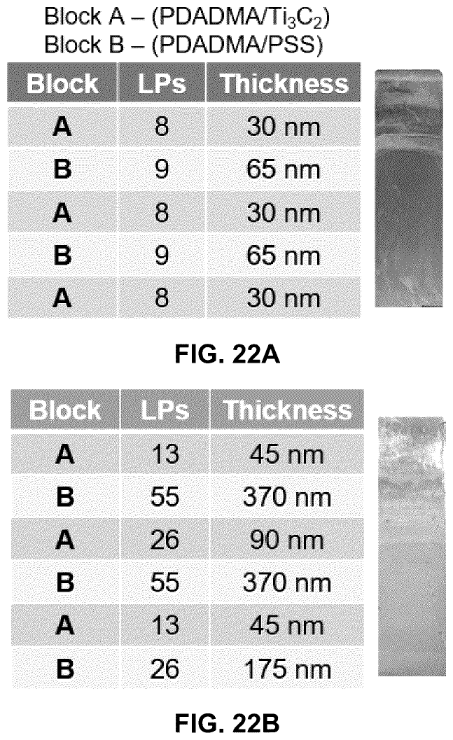

FIGS. 22A-22B show photographs and layer descriptions of two heterostructures on which humidity tests were performed. The blue heterostructure (FIG. 22A) is 41% block A (about 37% MXene in this block) and 59% block B, while the pink heterostructure (FIG. 22B) is 16% block A (about 14% MXene) and 84% block B. The pink heterostructure is about 5 times thicker than the blue heterostructure.

Colorimetric and resistance humidity responses were conducted as follows. A heterostructure was prepared; silver paste was used to mount wires, and the heterostructure was connected to a multimeter and placed in a chamber. Baseline values were obtained by holding the chamber at 0% RH for 30 min, then increasing to 80% RH. Resistance was recorded for every 10% RH increment after 0, 5, and 10 min. The experiment was then reversed, going from 80% RH to 0% RH, and repeated five times.

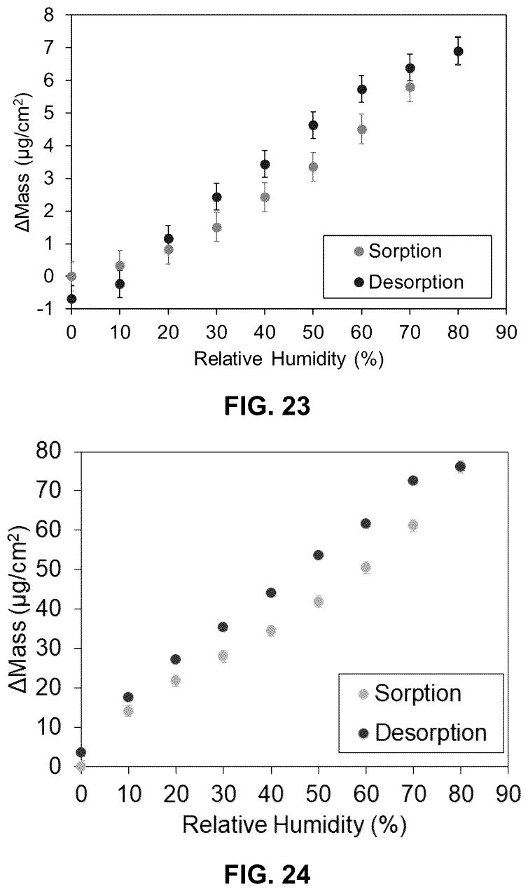

Film mass and humidity response experiments were conducted as follows. The heterostructure was coated onto a quartz crystal microbalance (QCM) crystal, gold contacts were cleaned, and the sample was inserted into a holder, which was placed into a chamber. Baseline values were obtained by holding the chamber at 0% RH for 30 min, then increasing to 80% RH. The QCM was run for 10 minutes at every 10% increment in RH. The experiment was repeated three times. 10% to 60% cycling was conducted 25 times as well, holding for 5 min at the endpoint. The QCM measures the mass change of the heterostructure under increasing and decreasing RH (i.e., the mass of the absorbed and/or desorbed moisture). As RH increases, mass increases, and as RH decreases, mass decreases. Hysteresis in the plot of mass change versus RH indicates that desorption typically has a slower rate than absorption for a blue heterostructure (see FIG. 23). Similar patterns were observed for the pink heterostructure (see FIG. 24) as for the blue heterostructure, although about 10 times more moisture was absorbed/desorbed by the pink heterostructure. A thicker film or greater percentage of polymer in the structure may lead to more sorption.

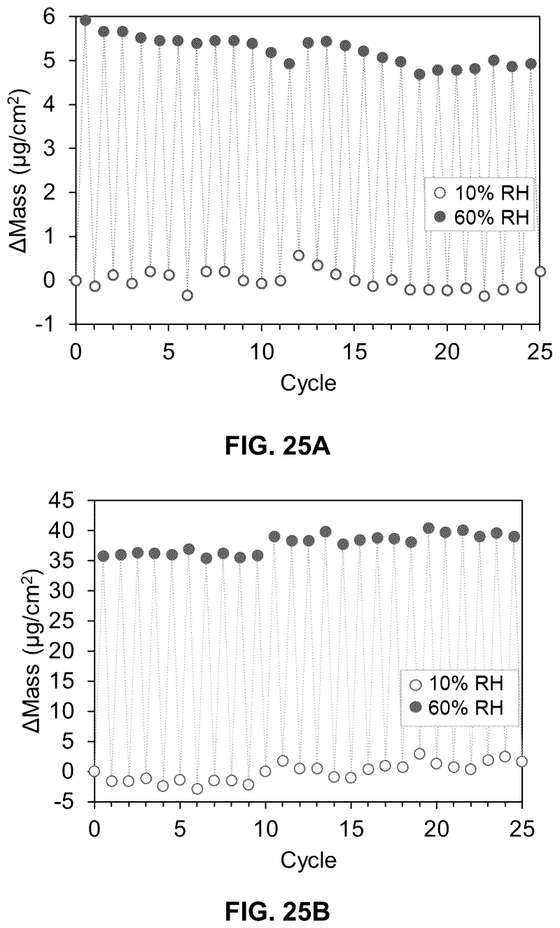

When cycling between 10% and 60% RH, variations in mass are dependent upon the particular heterostructure, with some variation in mass for 10% RH (blue heterostructure, FIG. 25A) but no noticeable drift. For 60%, after the 15^{th} cycle, some drift occurs, with less mass absorbed than for earlier cycles. With a pink heterostructure (FIG. 25B), a slight upward drift in mass was observed at both 10% and 60% RH; not all water desorbs from this heterostructure at 10%. If the same amount is being sorbed per cycle, drift also occurs at 60% RH.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. An, H. et al. Surface-agnostic highly stretchable and bendable conductive MXene multilayers. Sci. Adv. 4, eaaq0118 (2018).
2. An, H. et al. Water sorption in mxene/polyelectrolyte multilayers for ultrafast humidity sensing. ACS Appl. Nano Mater. 2, 948-955 (2019).
3. Beer Bestimmung der absorption des rothen Lichts in farbigen Flüssigkeiten. Ann. Phys. 162, 78-88 (1852).
4. Berdiyorov, G. R. Optical properties of functionalized Ti3C2T2 (T=F, O, OH) MXene: first-principles calculations. AIP Adv. 6, (2016).
5. Bian, F., et al. Bioinspired MXene-integrated colloidal crystal arrays for multichannel bioinformation coding. Proc. Natl Acad. Sci. 117, 22736-22742 (2020).
6. Busch, R. T. et al. Exfoliation procedure-dependent optical properties of solution deposited MoS2 films. npj 2D Mater. Appl. 7, 12 (2023).
7. Cao, H.; et al. Electrically conductive porous Ti3C2Tx MXene-polymer composites from high internal phase emulsions (HIPEs). 2D Materials 2022, 9 (4), 044004.
8. Caruso, F., et al. 1. Ultrathin multilayer polyelectrolyte films on gold: construction and thickness determination. Langmuir 13, 3422-3426 (1997).
9. Cauchy, A. L. Memoire sur la Dispersion de la Lumiere (Calve, 1836).
10. Chen, C. et al. Flower inspiration: broad-angle structural color through tunable hierarchical wrinkles in thin film multilayers. Adv. Funct. Mater. 31, 2006256 (2021).
11. Decher, G. et al. Buildup of ultrathin multilayer films by a self-assembly process, 1 consecutive adsorption of anionic and cationic bipolar amphiphiles on charged surfaces. Makromol. Chem. Macromol. Symposia 46, 321-327 (1991).
12. Decher, G. et al. In Trends in Colloid and Interface Science VI, Darmstadt (eds Helm, C., Lösche, M. & Möhwald, H.) 160-164 (Steinkopff, 1992).
13. Decher, G. Fuzzy nanoassemblies: toward layered polymeric multi-composites. Science 277, 1232-1237 (1997).
14. Decher, G., et al. New nanocomposite films for biosensors: layer-by-layer adsorbed films of polyelectrolytes, proteins or DNA. Biosens. Bioelectron. 9, 677-684 (1994).
15. Dillon, A. D. et al. Highly conductive optical quality solution-processed films of 2d titanium carbide. Adv. Funct. Mater. 26, 4162-4168 (2016).
16. Echols, I. J. et al. Conformal layer-by-layer assembly of Ti3C2T_{z} MXene-only thin films for optoelectronics and energy storage. Chem. Mater. 34, 4884-4895 (2022).
17. Echols, I. J. et al. pH-Response of polycation/Ti3C2Tx MXene layerby-layer assemblies for use as resistive sensors. Mol. Syst. Des. Eng. 5, 366-375 (2020).
18. Fang, H. et al. Signatures of Band-like Optical and Charge Transport in Ti3C2Tx MXene Flakes (American Chemical Society, A C S, 2024).
19. Fu, B. et al. MXenes: synthesis, optical properties, and applications in ultrafast photonics. Small 17, 2006054 (2021).
20. Ghidiu, M., et al. Conductive two-dimensional titanium carbide ‘clay’ with high volumetric capacitance. Nature 516, 78-81 (2014).
21. Gogotsi, Y. et al. The rise of MXenes. ACS Nano 13, 8491-8494 (2019).
22. Guin, T., et al. Water-based melanin multilayer thin films with broadband UV absorption. ACS Macro Lett. 4, 335-338 (2015).
23. Hantanasirisakul, K. et al. Fabrication of Ti3C2Tx MXene transparent thin films with tunable optoelectronic properties. Adv. Electron. Mater. 2, 1600050 (2016).
24. Harun-Ur-Rashid, M. et al. Angle-independent structural color in colloidal amorphous arrays. ChemPhysChem. 11, 579-583 (2010).
25. Huang, S., et al. Determination of optical constants of functional layer of online Low-E glass based on the Drude theory. Thin Solid Films 516, 3179-3183 (2008).
26. Kadi, M., et al. Analysis of optical and related properties of tin oxide thin films determined by Drude-Lorentz model. Surf. Coat. Technol. 211, 45-49 (2012).
27. Kashem, M. N. H., et al. Deciphering the correlation between color response, temperature, and relative humidity in a photo-patternable polymeric nanofilm for tunable multimodal display. Chem. Eng. J. 463, 142333 (2023).
28. Kim, Y.; et al. Reconfigurable chiroptical nanocomposites with chirality transfer from the macro- to the nanoscale. Nature Materials 2016, 15 (4), 461-468.
29. Kinoshita, S., et al. Physics of structural colors. Rep. Prog. Phys. 71, 076401 (2008).
30. Köhler, K., et al. Thermal behavior of polyelectrolyte multilayer microcapsules: 2. insight into molecular mechanisms for the PDADMAC/PSS system. J. Phys. Chem. B 110, 24002-24010 (2006).
31. Kurt, P., et al. Structural color via layer-by-layer deposition: layered nanoparticle arrays with near-UV and visible reflectivity bands. J. Mater. Chem. 19, 8920-8927 (2009).
32. Lambert, J. H. Photometria sive demensura et gradibus luminis, colorum et umbrae Sumptibus vidvae E. Klett, typis C. P. Detleffsen, 1760.
33. Lee, D., et al. All-nanoparticle thin-film coatings. Nano Lett. 6, 2305-2312 (2006).
34. Li, M. et al. Bioinspired light-driven photonic crystal actuator with MXene-hydrogel muscle. Cell Rep. Phys. Sci. 3, 100915 (2022).
35. Li, R., et al. MXene Ti3C2: an effective 2d light to-heat conversion material. ACS Nano 11, 3752-3759 (2017).
36. Liang, Z.; et al. Optical anisotropy and sign reversal in layer-by-layer assembled films from chiral nanoparticles. Faraday Discussions 2016, 191 (0), 141-157, 10.1039/C6FD00064A.
37. Liu, Y.-T. et al. Self-assembly of transition metal oxide nanostructures on mxene nanosheets for fast and stable lithium storage. Adv. Mater. 30, 1707334 (2018).
38. Luo, H. et al. Peaked dielectric responses in Ti3C2 MXene nanosheets enabled composites with efficient microwave absorption. J. Appl. Phys. 123, 104103 (2018).
39. Luther, R. et al. Über die Beziehungen zwischen den Absorptionsspektren und der Konstitution der komplexen Kobaltamminsalze. Z. Phys. Chem. 82U, 361-384 (1913).
40. Lutkenhaus, J. L., et al. Elastomeric flexible free-standing hydrogen-bonded nanoscale assemblies. J. Am. Chem. Soc. 127, 17228-17234 (2005).
41. Mason, C. W. Structural colors in Insects. II. J. Phys. Chem. 31, 321-354 (1927).
42. Mayerhöfer, T. G., et al. Employing theories far beyond their limits—the case of the (Boguer-) Beer-Lambert Law. ChemPhysChem. 17, 1948-1955 (2016).
43. Mueller, R., et al. Melting of PDADMAC/PSS capsules investigated with AFM force spectroscopy. Macromolecules 38, 9766-9771 (2005).
44. Naguib, M. et al. Two-dimensional nanocrystals produced by exfoliation of Ti3AlC₂. Adv. Mater. 23, 4248-4253 (2011).
45. Nogueira, G. M., et al. Spray-layer-by-layer assembly can more rapidly produce optical-quality multistack heterostructures. Langmuir 27, 7860-7867 (2011).
46. Nolte, A. J., et al. Creating effective refractive index gradients within polyelectrolyte multilayer films: molecularly assembled rugate filters. Langmuir 20, 3304-3310 (2004).
47. Pogreb, R., et al. Simultaneous determination of thickness and refractive index using Cauchy or Sellmeier formulas by the example of surface plasmon resonance study on ultrathin polysulfone film. Int. J. Polym. Anal. Charact. 26, 661-667 (2021).
48. Puzzo, D. P. et al. Color from colorless nanomaterials: Bragg reflectors made of nanoparticles. J. Mater. Chem. 19, 3500-3506 (2009).
49. Qi, Y. et al. Bar-coating programmable mechanochromic bilayer PDMS film with angle-dependent and angle-independent structural colors. Dyes Pigments 189, 109264 (2021).
50. Radovic, M. et al. MAX phases: bridging the gap between metals and ceramics. Am. Ceram. Soc. Bull. 92, 20-27 (2013).
51. Rashid, I. et al. Structural coloration in caloenas Nicobarica pigeons and refractive index modulated sensing. Adv. Opt. Mater. 6, 1701218 (2018).
52. Redel, E., et al. Hierarchical nanoparticle Bragg mirrors: tandem and gradient architectures. Small 7, 3465-3471 (2011).
53. Richardson, J. J. et al. Innovation in layer-by-layer assembly. Chem. Rev. 116, 14828-14867 (2016).
54. Richardson, J. J., et al. Technology-driven layer-by-layer assembly of nanofilms. Science 348, aaa2491 (2015).
55. Shevtsova, E., et al. Stable structural color patterns displayed on transparent insect wings. Proc. Natl Acad. Sci. 108, 668-673 (2011).
56. Sokol, M., et al. On the chemical diversity of the MAX phases. Trends Chem. 1, 210-223 (2019).
57. Vahid-Mohammadi, A., et al. The world of two-dimensional carbides and nitrides (MXenes). Science 372, eabf1581 (2021).
58. Vidyasagar, A., et al. Thermal transitions in dry and hydrated layer-by-layer assemblies exhibiting linear and exponential growth. ACS Nano 6, 6174-6184 (2012).
59. Wu, Z., et al. Structural color in porous, super-hydrophilic, and self-cleaning SiO2/TiO2 Bragg stacks. Small 3, 1445-1451 (2007).
60. Xue, P. et al. Bioinspired MXene-based soft actuators exhibiting angle-independent structural color. Nano-Micro Lett. 15, 1 (2022).
61. Yu, L. et al. Ultrafast colorimetric humidity-sensitive polyelectrolyte coating for touchless control. Mater. Horiz. 4, 72-82 (2017).
62. Yun, J. et al. Layer-by-layer assembly of reduced graphene oxide and MXene nanosheets for wire-shaped flexible supercapacitors. ACS Appl. Mater. Interfaces 13, 14068-14076 (2021).
63. Zhang, R., et al. Role of salt and water in the plasticization of PDAC/PSS polyelectrolyte assemblies. J. Phys. Chem. B 121, 322-333 (2017).
64. Zhang, X. et al. Three-dimensional electrochromic soft photonic crystals based on mxene-integrated blue phase liquid crystals for bioinspired visible and infrared camouflage. Angew. Chem. Int. Ed. 61, e202211030 (2022).
65. Zhao, X. et al. Antioxidants unlock shelf-stable Ti3C2Tx (MXene) nanosheet dispersions. Matter 1, 513-526 (2019).
66. Zhao, X. et al. pH, nanosheet concentration, and antioxidant affect the oxidation of Ti3C2Tx and Ti2CTx MXene dispersions. Adv. Mater. Interfaces 7, 2000845 (2020).
67. Zhou, J., et al. Thermoresponsive layer-by-layer assemblies for nanoparticle-based drug delivery. Langmuir 30, 5903-5910 (2014).
68. Zhou, L. et al. Dynamic structural color from wrinkled thin films. Adv. Opt. Mater. 8, 2000234 (2020).

What is claimed is:

1. A structurally-colored heterostructure comprising a substrate and a plurality of pairs of blocks, wherein each pair of blocks comprises a first block and a second block, wherein the first block comprises an MXene, and wherein the second block comprises one or more polyelectrolytes.

2. The structurally-colored heterostructure of claim 1, wherein the MXene has a formula of Mₙ₊₁XₙT_{z}, wherein M is a transition metal, X is carbon, nitrogen, or a combination thereof, n is an integer from 1 to 4, and T_{z} represents one or more terminal groups selected from —OH, —COOH, —O, —F, or any combination thereof

3. The structurally-colored heterostructure of claim 2, wherein M comprises Ti, V, Nb, or Mo.

4. The structurally-colored heterostructure of claim 1, wherein the polyelectrolyte comprises a polycation, a polyanion, or both.

5. The structurally-colored heterostructure of claim 1, wherein the first block and the second block comprise a polycation, wherein the polycation is the same in the first block and the second block.

6. The structurally-colored heterostructure of claim 4, wherein the polycation comprises polydiallyldimethylammonium (PDADMA), polyethylenimine, polyethylene oxide, polyallylamine hydrochloride, polyaniline, poly(vinylamine), chitosan, glutaraldehyde, or any combination thereof.

7. The structurally-colored heterostructure of claim 4, wherein the polyanion comprises polystyrene sulfonate (PSS), polyacrylic acid, polymethacrylic acid, polyethylene glycol, poly(2-acrylamido-2-methyl-1-propanesulfonic acid), polyvinylpyrrolidone, poly(N-isopropylacrylamide)-co-acrylic acid, polyacrylamide, or any combination thereof.

8. The structurally colored heterostructure of claim 1, wherein the first block, the second block, or both contain a salt.

9. The structurally colored heterostructure of claim 8, wherein the salt comprises NaCl.

10. The structurally-colored heterostructure of claim 1, wherein each first block and each second block comprise one or more layers of material.

11. The structurally-colored heterostructure of claim 1, wherein each of the plurality of pairs of blocks are the same or different.

12. The structurally-colored heterostructure of claim 2, wherein the first block comprises polydiallyldimethylammonium (PDADMA)/Ti₃C₂T_{z} and wherein the second block comprises PDADMA/polystyrene sulfonate (PSS).

13. The structurally-colored heterostructure of claim 1, wherein the substrate comprises glass, coated glass, silicon dioxide, a silicon wafer, a Ti/Au quartz crystal substrate, a fiber or fabric, a polymeric material, a plastic material, metal, or any combination thereof.

14. The structurally-colored heterostructure claim 1, wherein a color of the structurally-colored heterostructure appears identical to a standard observer independent of an angle of observation according to CIE 1931 color space.

15. The structurally-colored heterostructure claim 1, wherein a wavelength reflected from the structurally-colored heterostructure is identical regardless of an angle of measurement.

16. The structurally-colored heterostructure of claim 1, wherein a color of the structurally-colored heterostructure appears different to a standard observer at a first angle of observation and at a second angle of observation according to CIE 1931 color space.

17. The structurally-colored heterostructure of claim 1, wherein a wavelength reflected from the structurally-colored heterostructure is different at a first an angle of measurement and a second angle of measurement.

18. An article comprising the structurally-colored heterostructure of claim 1.

19. The article of claim 18, wherein the article comprises a Bragg reflector, an optical coating, a dielectric mirror, an optical limiting material, a humidity sensing device, a textile material, or any combination thereof.

20. A method for sensing humidity using the structurally-colored heterostructure of claim 1, the method comprising:
(a) measuring at least one physical quantity selected from color according to CIE 1931 color space, reflected wavelength, electrical resistance, or mass a first time;
(b) placing the structurally-colored heterostructure in an environment of unknown humidity;
(c) measuring the at least one physical quantity a second time; and
(d) comparing a change in the at least one physical quantity to a calibration curve for the structurally-colored heterostructure to determine humidity of the environment.
